(19) United States
(12) Patent Application Publication
(10) Pub. No.: US 2012/0327942 A1
(43) Pub. Date: Dec. 27, 2012

(54) COMMUNICATION NETWORK SYSTEM

(75) Inventors: Masayoshi Terabe, Dusseldorf (DE); Motoi Ichihashi, Nagoya-city (JP); Yuuki Horii, Kariya-city (JP); Takashi Abe, Kariya-city (JP)

(73) Assignee: DENSO CORPORATION, Kariya-city (JP)

(21) Appl. No.: 13/532,958

(22) Filed: Jun. 26, 2012

(30) Foreign Application Priority Data
Jun. 27, 2011 (JP) 2011-141748
Sep. 8, 2011 (JP) 2011-196054

(51) Int. Cl. H04L 12/56

(52) U.S. Cl. 370/400

(57) ABSTRACT

A communication network system including a plurality of nodes disposed on a communication bus, and where each of the nodes is capable of transitioning between a normal operation mode and a low electricity consumption mode. The communication network system controls only a required node, in order to communicate with such required node, by transitioning the required node from the low power mode to the normal operation mode. To control the mode of the required nodes, a controlling node keeps a signal change state of the communication bus for a period that is longer than a normal communication frame length. The required node determines whether the period of the signal change state is longer than a threshold of the required node itself, to output a wakeup signal to a control circuit.

### CROSS REFERENCE TO RELATED APPLICATION

The present application is based on and claims the benefit of priority of Japanese Patent Applications No. 2011-141748, filed on Jun. 27, 2011, and No. 2011-196054, filed on Sep. 8, 2011, the disclosures of which are incorporated herein by reference.

### TECHNICAL FIELD

The present disclosure generally relates to a communication network system that has multiple nodes connected to a communication line respectively transitional between a normal operation mode and a low electricity consumption mode.

### BACKGROUND

Each communication node, such as an electronic control unit (ECU) is configured, for example, to transition to a standby mode in an in-vehicle network when certain conditions for saving electricity consumption are satisfied. In such mode, supply of a system clock for the nodes transitioning to the standby mode is typically stopped. Then, if one of the nodes starts to communicate with the other nodes as a controlling node, the other nodes in the standby mode are “waken up” and shift to the normal operation mode. However, the controlling node does not have to communicate with all of the other nodes on the in-vehicle network. Therefore, it is preferable and efficient to wake up only a destination node or destination nodes which serve as a destination of data communication from the controlling node. A technique in Japanese Patent Laid-Open No. 2010-280314 (JP '314) (US 2010/0312417) realizes a network that wakes up only a part of the other nodes on the network by transmitting a wakeup signal individually to the required nodes on the network through dedicated signal lines for transmitting the wakeup signal, which are added to the network.

However, the technique in JP '314 may require an increase in signal lines when the number of nodes on the network increases. Such increase of signal lines is against the requirement of reducing the number of signal lines in the network. Further, a management node that controls the wakeup of the other nodes is restricted to only one node. Therefore, such control scheme of JP '314 may not have flexibility.

### SUMMARY

In an aspect of the present disclosure, a communication network system includes a communication line and a plurality of nodes. Each of the plurality of nodes includes a control unit for performing a communication control, a change state detection unit for detecting a signal change state of the communication line, and a startup signal output unit for outputting a startup signal to the control unit according to a continuation time of the signal change state. In addition, each of the nodes is also able to transition between a normal operation mode (i.e. normal mode) and a low electricity consumption mode (i.e. low mode).

At least one of the plurality of nodes may be provided as a communication starting that initiates communication on the network among other nodes by transitioning the nodes from the low mode to the normal mode by providing a signal change state for a continuation period that is longer than one frame length of a normal communication. When the change state detection unit of a subject node, which is transitioning to the low mode, detects such continuation of the signal change state, the startup signal output unit of the subject node provides a startup signal to the control unit of the subject node to transition to the normal mode, if a continuation period of the detected signal change state is longer than a threshold for the subject node.

Specifically, when a node currently in a low electricity consumption mode wakes up to transition to a normal mode for a normal operation, the system keeps a signal change state on a communication line for a longer period that is longer than one frame length of a normal communication, and such signal change state causes a control unit of the subject node on the network to transition to the normal mode at a time of detecting an over-threshold continuation of the signal change state by the change state detection unit.

According to the communication network system described above, the change state detection unit detects a rise of a detection voltage level that rises according to a continuation period of signal level reversing change. For example, if a signal has two levels such as a high level and a low level, the node transitioning to the low electricity consumption mode can determine whether a release request to release such transition to the “low” mode of the node itself has been output or not by counting the number of edges detected as transitions (i.e., signal changes) between the two levels.

According to the communication network system described above, the change state detection unit includes a pulse signal output unit for outputting a pulse signal at a time of one-way reversing of a signal level and a capacitor that is charged by the pulse signal. The startup signal output unit includes a comparator that compares a charge voltage of the capacitor and a preset threshold. In such manner, the pulse signal is output each time the rising edge of the signal level change from, for example, the low level to the high level is detected, and the capacitor is charged by such pulse signal. Due to such rising edge detection at regular intervals, which leads to successive outputs of the pulse signal, the charge voltage of the capacitor rises. When the charge voltage exceeds the threshold, the comparator outputs the startup signal to the control unit.

In another aspect of the present disclosure, a communication network system includes a plurality of nodes respectively having a clock multiplication unit for outputting a multiplied clock signal that is a multiplication of a reference clock signal; and an interface unit that controls the clock multiplication unit and transmits/receives a signal through the communication line according to a selective supply of one of the multiplied clock signal and the reference clock signal, which is under control of the interface unit itself.

Further, the interface unit in a low electricity consumption mode (i.e., a low mode) stops the operation of the clock multiplication unit, stops power supply for a control unit, and supplies the reference clock signal for the interface unit itself, to prepare for starting the operation of the clock multiplication unit and to supply the multiplied clock signal to the interface unit itself upon receiving a startup signal from an other node.

In other words, because the interface unit is the only section operating in a node that is put in the “low” mode, having a supply of a reference clock signal only, thereby sufficiently reducing the power consumption. Then, upon receiving the startup signal, the interface unit starts the operation of the clock multiplication unit and supplies the multiplied clock signal to itself, thereby enabling the control unit to operate at “high speed” for performing the normal communication. In addition, there is no need to have an additional line for exclusively starting up each of communication destination nodes, which enables the reduction of the number of communication lines.

According to the communication network system described above, each of the nodes switches the interface unit to supply the reference clock signal to the interface unit itself when a transmitting node in the in the normal operation mode transmits the startup signal to the other node. In such manner, the transmitting node can transmit the startup signal at a low speed.

According to the communication network system described above, when the interface unit transmits the startup signal to the other node(s), the interface unit transmits the startup, signal at a communication rate set by the reference clock signal in a state of having the multiplied clock signal supplied for the interface unit itself. Therefore, the interface unit needs not switch the clock signal supplied for itself, to transmit the startup signal at the low speed.

### BRIEF DESCRIPTION OF THE DRAWINGS

Other objects, features and advantages of the present disclosure will become more apparent from the following detailed description disposed with reference to the accompanying drawings, in which:

FIG. 1 is a timing chart of signal wave forms of a communication network system in a first embodiment of the present disclosure;

FIG. 2 is a block diagram of a squelch circuit in the first embodiment of the present disclosure;

FIGS. 3A, 3B, 3C, 3D are illustrations of signal wave forms of the squelch circuit of FIG. 2;

FIG. 4 is a block diagram of a reception side of each node in the first embodiment of the present disclosure;

FIG. 5 is a block diagram of a transmission side of each node in the first embodiment of the present disclosure;

FIG. 6 is a block diagram of the communication network system in the first embodiment of the present disclosure;

FIG. 7 is a block diagram of a reception side of each node in a second embodiment of the present disclosure;

FIG. 8 is a flowchart of a process of the reception side in the second embodiment of the present disclosure;

FIG. 9 is a timing chart of signal wave forms of a communication network system in the second embodiment of the present disclosure;

FIG. 10 is a timing chart of signal wave forms of the communication network system in the second embodiment of the present disclosure;

FIG. 11 is a timing chart of signal wave forms of a communication network system in a third embodiment of the present disclosure;

FIG. 12 is a block diagram of a reception side of each node in a fourth embodiment of the present disclosure;

FIG. 13 is a block diagram of a wakeup determination circuit in the fourth embodiment of the present disclosure;

FIG. 14 is a timing chart of signal wave forms of a communication network system in the fourth embodiment of the present disclosure;

FIGS. 15A, 15B are timing charts of signal wave forms of a communication network system in a fifth embodiment of the present disclosure;

FIG. 16 is a timing chart of signal wave forms of a communication network system in a sixth embodiment of the present disclosure;

FIG. 17 is a timing chart of signal wave forms of a communication network system in a seventh embodiment of the present disclosure;

FIG. 18 is a block diagram of the squelch circuit in the seventh embodiment of the present disclosure;

FIG. 19 is a timing chart of signal wave forms of a communication network system in an eighth embodiment of the present disclosure;

FIG. 20 is a block diagram of a communication network system in a ninth embodiment of the present disclosure;

FIG. 21 is a block diagram of the communication network system in the ninth embodiment of the present disclosure;

FIG. 22 is a block diagram of the communication network system in the ninth embodiment of the present disclosure;

FIGS. 23A, 23B are block diagrams of a reference clock circuit of the communication network system in the ninth embodiment of the present disclosure;

FIGS. 24A,24B are block diagrams of in-chip configuration of the communication network system in the ninth embodiment of the present disclosure;

FIGS. 25A, 25B, 25C are illustrations of a control method of a power supply of the communication network system in the ninth embodiment of the present disclosure;

FIG. 26 is a state transition diagram of a chip of the communication network system in the ninth embodiment of the present disclosure;

FIG. 27 is a chip state table of the communication network system in the ninth embodiment of the present disclosure;

FIG. 28 is an illustration of a command frame of a wakeup signal in the ninth embodiment of the present disclosure;

FIGS. 29A, 29B are timing charts of the wakeup signal in the ninth embodiment of the present disclosure;

FIG. 30 is a flowchart of a transmission process for transmitting the wakeup signal in a tenth embodiment of the present disclosure;

FIG. 31 is a block diagram of an interface unit in an eleventh embodiment of the present disclosure;

FIG. 32 is an illustration of an input buffer circuit in the eleventh embodiment of the present disclosure;

FIG. 33 is a block diagram of a communication network system in a twelfth embodiment of the present disclosure;

FIG. 34 is a block diagram of a communication network system in a thirteenth embodiment of the present disclosure;

FIG. 35 is a block diagram of a communication network system in a fourteenth embodiment of the present disclosure; and

FIGS. 36A, 36B are block diagrams of a communication network system in a fifteenth embodiment of the present disclosure.

### DETAILED DESCRIPTION

### First Embodiment

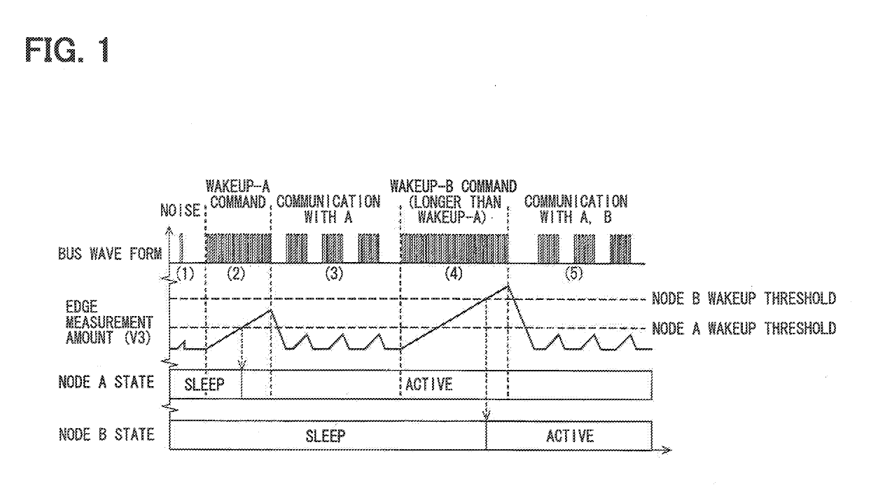

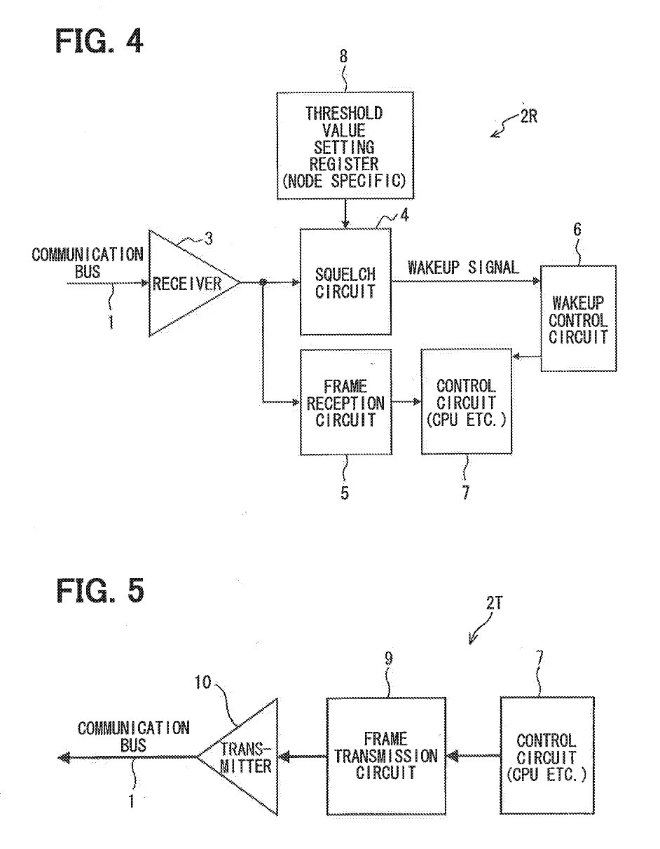

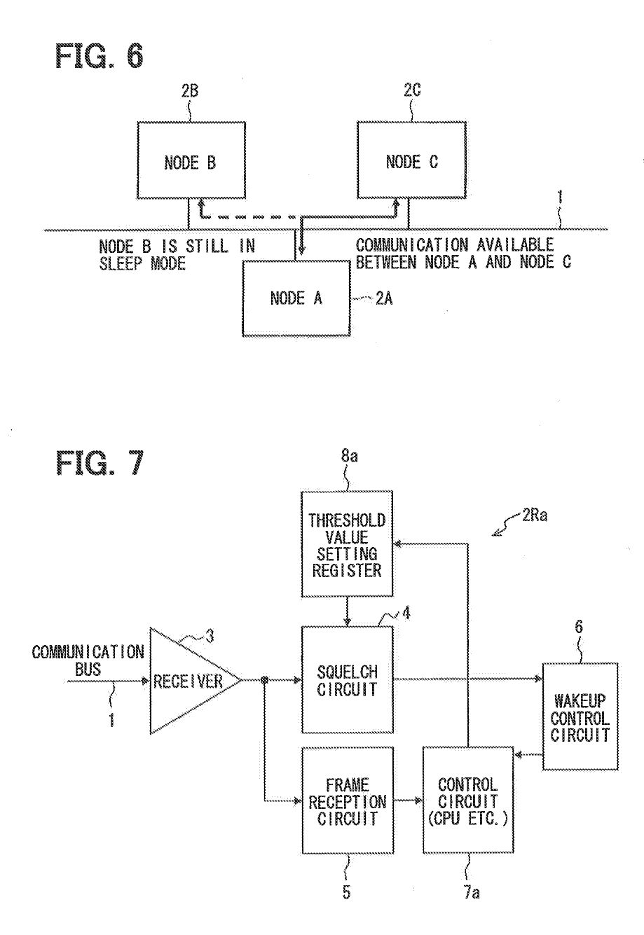

The first embodiment of the present disclosure is described with reference to FIGS. 1 to 6. With reference to FIG. 6, a communication network system includes a communication bus 1 (i.e., a communication line) with a node 2A (i.e., Node A), a node 2B (i.e., Node B), and a node 2C (i.e., a Node C) connected thereto. The nodes 2A, 2B, 2C may be referred to as nodes 2 in the following. Each of the nodes 2A, 2B, 2C is switchable, such that the nodes 2A, 2B, 2C may transition between two operation modes, such as a normal operation mode/state (i.e., an active mode or active state) and a low electricity consumption mode/state (i.e., a sleep mode or sleep state). In the normal operation mode, each of the nodes 2A, 2B, 2C is controlled in an integral manner, such that a control circuit 7 (FIG. 4) of each of the node 2A, 2B, 2C has a clock signal supplied thereto for its operation. The control circuit 7 of each node 2A, 2B, 2C may be formed as a CPU or as a microcomputer. In the low electricity consumption mode, the operation of the control circuit 7 stops due to a stop of supply of the clock signal. In such state, the electricity consumption of the control circuit 7 is reduced. The low electricity consumption mode may also be designated as a standby mode or a low power mode. Though FIG. 6 depicts three nodes, the communication bus 1 may include two nodes or may include more than three nodes, and is not limited to three nodes.

In the present embodiment, a partial network of establishing communication between the node 2C and the node 2A by the wake up of only the node 2A under control of the node 2C is described. Before such wake up, both of the node 2A and the node 2B are in a sleep mode, and the node 2C is active (i.e., normal operation).

FIG. 4 is a block diagram of a reception side of each of the nodes 2A, 2B, 2C, that is, the block diagram of a reception unit 2R. The signal output to the communication bus 1 is received by a receiver 3. The received signal is input to a squelch circuit 4 (i.e., a change state detection unit, a startup signal output unit in claims) and to a frame reception circuit 5. The squelch circuit 4 outputs a wakeup signal to a wakeup control circuit 6 according to the output state of the received signal. In a threshold value setting register 8, different register values are fixedly set for respective nodes 2A, 2B, 2C, and a threshold, which is exceeded or surpassed to output the wakeup signal from the squelch circuit 4, is determined based on such register value. Thus, a different threshold may be provided for each of the nodes 2A, 2B, 2C. The wakeup control circuit 6 outputs a startup signal to the control circuit 7 (i.e., a control unit) by latching on to the wakeup signal described above. The frame reception circuit 5 outputs data, which is demodulated from the received signal to the control circuit 7. The control circuit 7 accepts and processes the received data when the control circuit 7 is active.

FIG. 5 is a block diagram of a transmission side of each of the nodes 2A, 2B, 2C, that is, the block diagram of a transmission unit 2T. The data transmitted by the control circuit 7, which is shared with the reception unit 2R, is transmitted through a transmitter 10 to the communication bus 1 after modulation by a frame transmission circuit 9. In such case, the communication bus 1 transmits a differential signal by using a pair of signal lines, for example, R+, R−, and, in a non-drive state, each of the signal lines R+, R− shows a midpoint electric potential. In a drive state, the electric potential of the signal line R+ side rises, and the electric potential of signal line R− side falls, thereby transmitting the differential signal. Alternatively, in the drive state, a high electric potential state of the signal line R+ is considered as a high level, and, when such high level is reversed, a low electric potential state of the signal line R+ is considered as a low level. The receiver 3 in the reception unit 2R outputs, to the squelch circuit 4, a pulse signal which is the difference voltage between the signal lines R+ and R−.

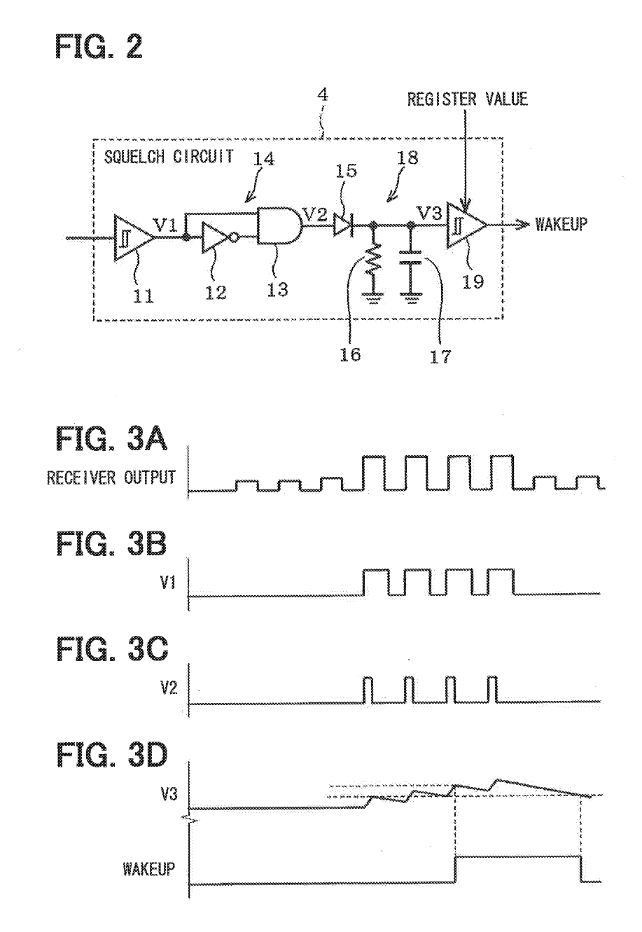

FIG. 2 shows an example of the squelch circuit 4. The squelch circuit 4 includes a hysteresis comparator 11, a rising edge detection circuit 14, an integration circuit 18, and a Schmitt trigger circuit 19. The rising edge detection circuit 14 has a NOT gate 12 and an AND gate 13. The integration circuit 18 has a diode 15, a resistor 16, and a capacitor 17.

With reference to FIGS. 3A to 3D, the hysteresis comparator 11 outputs a pulse signal V1, which has a high level in comparison to the threshold in the comparator 11 when a pulse signal is provided by the receiver 3. Therefore, when the data is transmitted from one of the nodes 2A, 2B, 2C on the transmission side to the communication bus 1 (i.e., when the node 2C on the transmission side drives the communication bus 1 for transmitting data) and a pulse exceeding the threshold of the hysteresis comparator 11 is inputted, the pulse signal V1 is provided from the comparator 11. The rising edge detection circuit 14 outputs a signal V2 having a pulse width equivalent to delay of the NOT gate 12 when it detects a rising edge of the signal V1. The output signal V2 is provided as a signal V3 to the Schmitt trigger circuit 19 via the diode 15, and the Schmitt trigger circuit 19 outputs the wakeup signal (i.e., a startup signal).

In other words, each time the rising edge detection circuit 14 outputs the pulse of the signal V2, the capacitor 17 is charged via the diode 15, and the electric potential of the signal V3 rises accordingly. When the rising edge detection circuit 14 stops providing the signal V2, the electric potential of the signal V3 gradually falls as the electric power stored in the capacitor 17 is discharged through the resistor 16.

Therefore, the electric potential of the signal V3 rises gradually when the electric potential amplitude of the differential signal on the communication bus 1 continuously changes in a manner that alternately intersects with the threshold of the hysteresis comparator 11. When, due to such rise of the potential, the electric potential of the differential signal exceeds a threshold voltage Vr1 of the Schmitt trigger circuit 19, the wakeup signal changes from the low level to the high level (i.e., active).

On the other hand, the electric potential of the signal V3 falls gradually if the electric potential amplitude of the differential signal does not substantially change and a below-threshold state of the potential is kept. When the electric potential of the differential signal falls below a threshold voltage Vr2 of the Schmitt trigger circuit 19, the wakeup signal changes to a low level.

Further, a hysteresis-added threshold of the Schmitt trigger circuit 19 is configured to be changeable according to the register value set in the threshold value setting register 8. For example, according to the register value, the resistor value of a resistor circuit that sets such threshold is changed.

The advantageous effects of the present embodiment are described with reference to FIG. 1, For brevity, the nodes 2A, 2B, 2C may simply be referred to as “A”, “B”, “C” in FIG. 1 and similar drawings, such that “WAKEUP-A” of FIG.1 refers to wakeup command for the node 2A. As for an initial state, the node 2C is active, and the nodes 2A, 2B are sleep (see (1) of FIG. 1). From such state, the node 2C releases the sleep state of the node 2A, for performing communication, in which the node A is set as a destination of data transmission. For releasing the sleep mode of the node 2A, the node 2C drives the communication bus 1 through the transmitter 10 continuously. In other words, the level of the differential signal is continuously changed so that the data values “0” and “1” are alternately provided to the communication bus 1. Then, at the nodes 2A and 2B, the level of the signal V3 in the squelch circuits 4 of each of the nodes 2A, 2B (i.e., the detection voltage level) continues to rise.

At such moment, the node 2C continues the continuous change mentioned above to an extent that exceeds the time length defined as a normal communication frame length to wake up the node 2A. As the level of the signal V3 continues to rise, the level of the signal V3 exceeds the threshold of the squelch circuit 4 of the node 2A (see (2) of FIG. 1), and the squelch circuit 4 of the node 2A outputs the wakeup signal, which leads to the output of the startup signal from the wakeup control circuit 6 and leads to the transition of the control circuit 7 of the node 2A from the sleep state to the active state. In other words, the continuous change of the signal for a period that is longer than the normal communication frame length leads to transmission of the wakeup command to the node 2A.

Regarding the above, an edge measurement amount, which is the level of the signal V3, indicates a time period of a continuous detection of the rising edge of the differential signal. In other words, the rise of the level of the signal V3 indicates that the number of edge detections (i.e., the edge measurement amount) is high.

When the node 2A becomes active, communication with node 2A is available and the node 2C may transmit data to the node 2A (see (3) of FIG. 1). Because the normal communication frame length is shorter than the wakeup command transmission period, the squelch circuit 4 o the node 2A does not output the wakeup signal in the communication period.

Then, the node 2C causes the continuous change of the differential signal again, to wakeup the node 2B in order to communicate with the node 2B. Because the threshold of the squelch circuit 4 of the node 2B is higher than the squelch circuit 4 of the node 2A, the node 2C keeps the above-described continuous change for a longer period (see (4) of FIG. 1) than the period (2) of FIG. 1. When the level of the signal V3 exceeds the threshold of the squelch o circuit 4 of the node 2B after continuous rise, the squelch circuit 4 of the node 2B outputs the wakeup signal and the control circuit 7 of the node 2B transitions from the sleep state to the active state. Since the node 2A and 2B are active, communication with the node 2A and 2B is available, and the node 2C may transmit data to both the nodes 2A, 2B (see (5) of FIG. 1).

As described above, when the node 2C, which initiates the communication in the present embodiment, controls the node 2A to transition from the low electricity consumption mode (i.e., the sleep mode) to the normal operation mode (i.e., the active mode), the node 2C keeps the signal change state on the communication bus 1 for a longer period that is longer than the normal communication frame length (i.e., time of one frame). Then, upon detecting that the signal change state on the communication line, which is detected by the squelch circuit 4 of the node 2A, is kept for a period that is longer than the threshold assigned to the node 2A, the wakeup control circuit 6 of the node 2A outputs the wakeup signal to transition the control circuit 7 of the node 2A to the active state, and the node 2A is available for communication.

In other words, the squelch circuit 4 can detect the continuation period of the signal change state on the communication bus 1 even when the control circuit 7 is “sleeping.” Further, such longer continuation of the signal change state for a period that is longer than the normal communication frame length enables an easy detection of the irregular output state of the signal.

Therefore, by interpreting a continuation of the signal change state described above as the wakeup command that releases the sleep state and by outputting the wakeup signal to respective control circuits 7 according to the comparison results with the respectively different thresholds of the nodes 2, the partial network that starts up only the nodes 2 required for communication and that enables the reduction of electricity consumption is achieved, without adding a dedicated signal line.

Further, the startup of a node 2A, 2B, 2C as a destination of communication is enabled without limiting any function, such as the wake up function, to such node, since it is possible to keep the signal change state for a longer period that is longer than one frame length of the normal communication for each of the all nodes 2A, 2B, 2C.

Further, the squelch circuit 4 is configured to have the detection voltage level raised according to the period of continuation of the signal level reversing change. More practically, by forming the squelch circuit 4 with the rising edge detection circuit 14 that outputs the pulse signal each time the signal rising edge is detected and the capacitor 17 that is charged by such pulse signal, the charge voltage of the capacitor 17 is compared with a preset threshold level by using the Schmitt trigger circuit 19 for the output of the wakeup signal. Therefore, whenever the rising edge of the differential signal is detected, the pulse signal is output and the capacitor 17 is charged, thereby enabling the output of the startup signal from the Schmitt trigger circuit 19 to the control circuit 7 at a time when the charge voltage of the capacitor 17 exceeds the threshold level.

In general, based on (i) detection of how long the signal change state on the communication bus is being continued by a peripheral circuit (i.e., the change state detection unit) which is operable even in the low mode, and (ii) detection of such continuation of the signal change state for an over-threshold length, the signal change state can be used as a “command” for controlling the nodes, and a threshold length of each node may set to a different value for respective nodes for, for example, a wakeup of only a part of the nodes on the network. That is, in such manner, such state (i.e., continuation of the signal change state) may be un-ambiguously used (i.e., interpreted) as a release command for releasing the low mode, and each node may wake itself up based on (i) comparison of the release command with a node-specific threshold of such continuation and (ii) output of the startup signal to the control unit of each node. Thus, only the relevant nodes are woken up to perform communication, without using additional/dedicated signal lines for transmitting the startup signal to the individual nodes. As a result, the power consumption of such communication system is reduced.

### Second Embodiment

FIGS. 7 to 10 illustrates the second embodiment, in which the description is focused on the difference from the first embodiment. In addition, like parts have like numbers, and the description of the like parts is omitted. With reference to FIG. 7, a reception unit 2Ra of the second embodiment includes a threshold value setting register 8a, where the register value of the threshold value setting register 8a is changeable by a control circuit 7a. When the control circuit 7a receives a threshold value change command from the node 2 from the transmission side (i.e., the transmission unit 2T), it writes a setting data added to such command to the threshold value setting register 8a, and changes the threshold of the Schmitt trigger circuit 19 in the squelch circuit 4. The rest of the configuration of the reception unit 2Ra is same as the first embodiment.

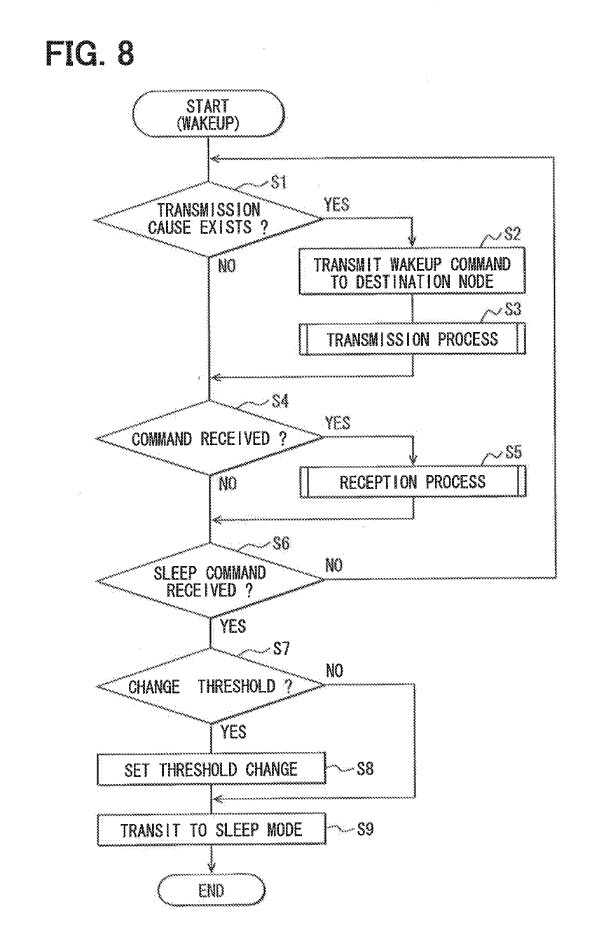

The advantageous effects of the second embodiment are described with reference to FIG. 8 to FIG. 10.

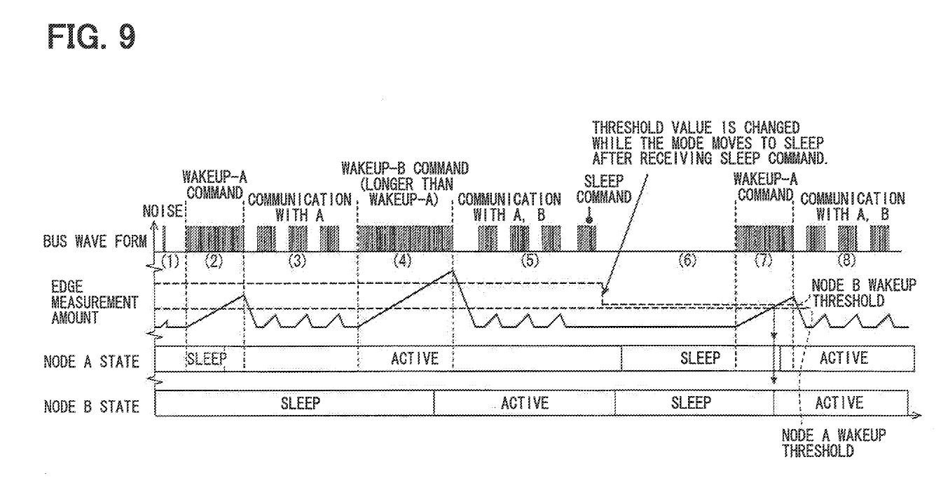

With reference to FIG. 9, just like the first embodiment, the node 2C communicates with the node 2A first, and then communicates with the nodes 2A, 23 successively (see (1) to (5) of FIG. 9). The node 2B then transitions to a sleep mode when a sleep command is transmitted by the node 2C, where, immediately before transiting to the sleep mode, the register value in the threshold value setting register 8a of the node 2B is changed by the control circuit 7a of the node 2B (see (6) to (8) of FIG. 9). In the example of FIG. 9, the threshold is changed to the same value as the node 2A.

FIG. 8 is a flowchart of a process performed by the control circuit 7a of a node 2. When the control circuit 7a is started per the wakeup signal from the squelch circuit 4, it determines whether there is data that needs to be transmitted (i.e., a transmission cause) to other nodes 2 (step S1). When there is a transmission cause (step S1 :YES), the control circuit 7a performs a transmission process (step S3) after transmitting the wakeup command to the node 2 which is considered as the communication destination (step S2).

Further, when the control circuit 7a receives command data transmitted from other nodes 2 (step S4:YES), it performs a reception process (step S5) to receive the data (i.e., command). The control circuit 7a then determines whether it has received a sleep command (step S6), and returns to step S1 if it has not received the sleep command (step S6:NO). If a sleep command has been received (step S6:YES), the control circuit 7a determines whether to change the threshold (step S7).

In the above, the determination by the control circuit 7a of a node 2 is controlled by the control program performed therein, and such determination may be changed if the determination needs to be changed according to the operation state of the application program or the like. If the threshold is changed (step S7:YES), the process proceeds to step S9 to transition to the sleep mode after rewriting the register value of the threshold value setting register 8a (step S8). In other words, the output of a clock signal supplied for the control circuit 7a is stopped. Therefore, as shown in FIG. 9 (7), (8), the nodes 2A, 2B are started at the same time when the node 2C transmits the wakeup command for starting up the node 2A next time.

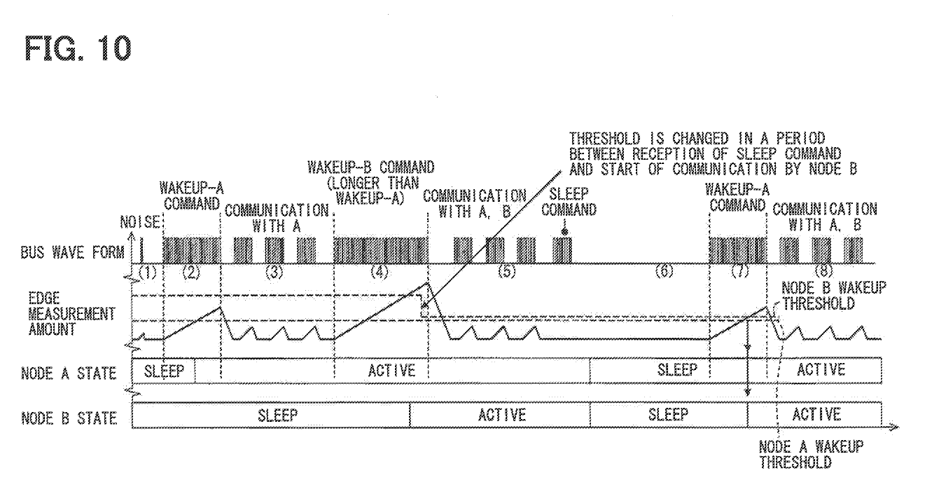

Further, FIG. 10 shows a timing chart when the control circuit 7a of the node 2B changes a register value of the threshold value setting register 8a immediately after the wakeup of the node 2B by the node 2C through the wakeup command (see (1)-(8) in FIG. 10). In such case, steps S7, S8 of FIG. 8 are moved to the YES branch of step S1.

According to the second embodiment, the node 2B on the reception side changes the threshold of the squelch circuit 4 at a timing (i) immediately before transition to the sleep mode or (ii) immediately after transition to the normal operation mode by the reception of the wakeup command, thereby allowing the reception side to change the threshold at timings that are appropriate for respective nodes.

According to the communication network system described above, the change state detection unit (i.e., the squelch circuit 4) has a variable threshold that can be changed. In such case, the longer a continuation period of the signal change state is, the greater the number of the nodes in which the threshold is exceeded and the startup signal is output based on the longer continuation period of the signal change state. For example, both node 2A, having a high threshold H, and a node 2B, having a low threshold L (H>L), are started up as the communication destination after the continuation of the signal change state exceeding the high threshold H, which may or may not be intended, depending on the situation. Therefore, if the user intends to start up only the node 2A having the threshold H as the communication destination, the threshold settings for the nodes 2A, 28 can be reversed, and only the node 2A now having the low threshold L can be started up.

Based on the communication network system of described above, the change state detection unit (i.e., the squelch circuit 4) is configured to increase a level of an output voltage according to a continuation period of the signal change state, and the startup signal output unit (i,e., the squelch circuit 4) includes a comparator (i.e., Schmitt trigger circuit 19) for comparing the level of the output voltage with the threshold, and the threshold set in the comparator is changeable. Therefore, by variably changing the threshold set in the comparator, the threshold for determining the release request can be changed.

### Third Embodiment

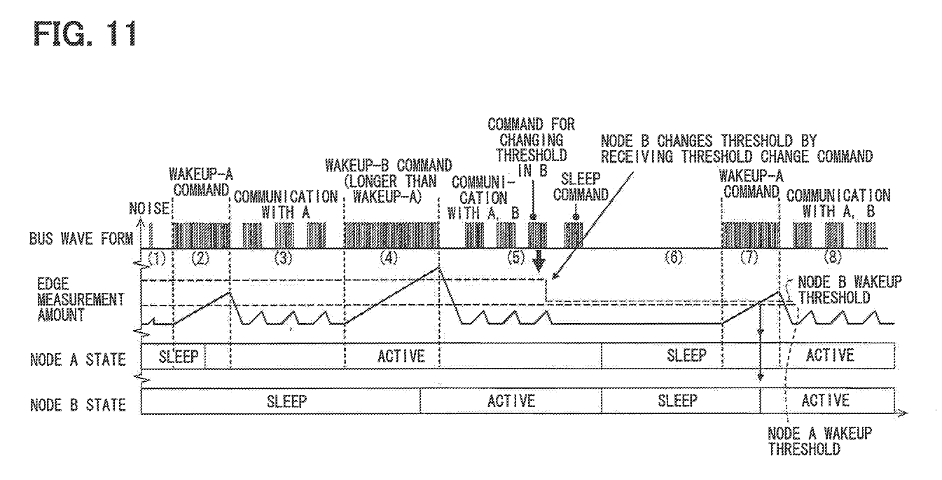

The third embodiment is described with reference to FIG. 11, and with a focus to the difference from the second embodiment. The third embodiment describes a situation where the threshold change of the squelch circuit 4 of the node 28 on the reception side is performed based on a threshold change command that is transmitted by the node 2C. The node 2C starts up the nodes 2A and 2B and communicates with both, and, after transmitting the threshold change command to the node 2B, it transmits the sleep command. When the node 2B receives the threshold change command, the control circuit 7a of the node 2B rewrites the register value of the threshold value setting register 8a of the node 2B according to a value specified by the command. Then, by receiving the sleep command, the node 2B transitions to the sleep mode, just like the second embodiment (see (1)-(8) of FIG. 11).

As described above, since the change of the threshold in the third embodiment is performed according to the change command that is transmitted by the node 2C on the transmission side, the change of the threshold is performed according to the determination by the node 2C.

Therefore, according to the communication network system described above, a transmission side (2T) of a node transmits a change command to change the threshold of other node. In such manner, the transmission side node can determine and change the threshold.

According to the communication network system described above, a reception side (2R) of a node changes the threshold, either (i) immediately before transition to the low electricity consumption mode or (ii) immediately after transition to the normal operation mode. In such manner, the threshold change can be performed at an appropriate timing that is determined by the reception side node.

### Fourth Embodiment

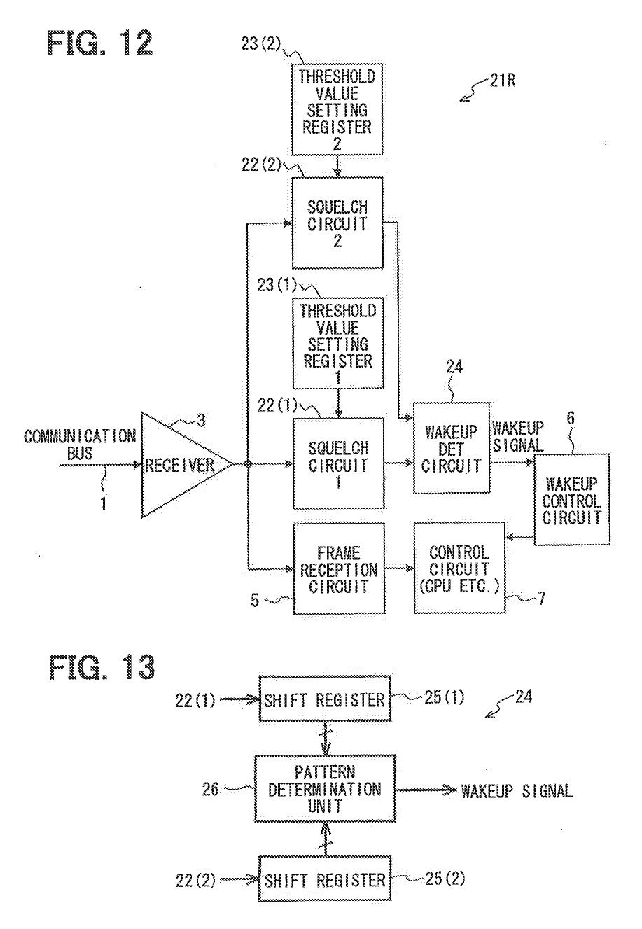

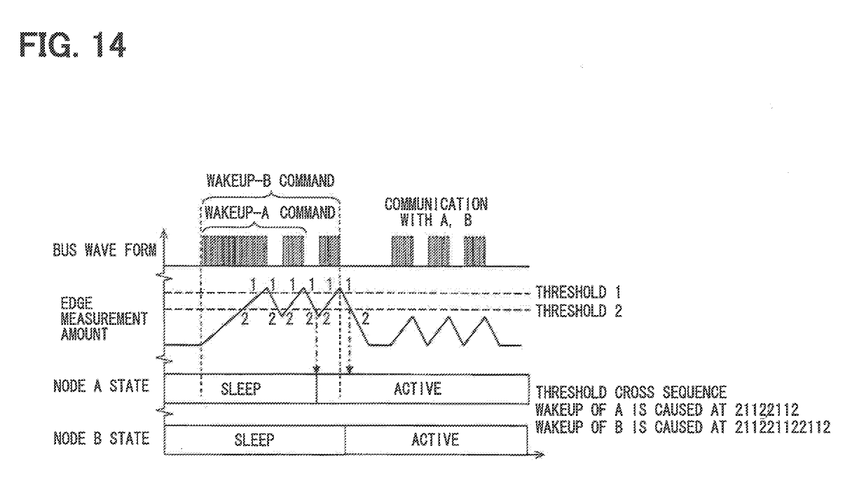

FIGS. 12 to 14 illustrate the fourth embodiment. With reference to FIG. 12, a reception unit 21R includes two squelch circuits 22 (1), 22 (2), and the last stage of the squelch circuits 22 (1), 22 (2) is not the Schmitt trigger circuit 19 but is a normal comparator (not illustrated). In addition, the reception unit 21R includes two threshold value setting registers 23 (1), 23 (2). The threshold value setting registers 23 (1), 23 (2) set respectively different levels (e.g., threshold 1 and threshold 2, respectively, where threshold 1>threshold 2 shown in FIG. 14) for the normal comparator used in the last stage of the squelch circuits 22 (1), 22 (2), respectively, The output signals from the two squelch circuits 22 (1), 22 (2) are provided to a wakeup determination circuit 24, and the wakeup determination circuit 24 determines whether the pattern of the output signals matches with a preset pattern. If the patterns match with the preset pattern, the wakeup signal is provided.

FIG. 13 is a block diagram of the wakeup determination circuit 24. The wakeup determination circuit 24 includes two shift registers 25 (1), 25 (2) that receive the output signals from the squelch circuits 22 (1), 22 (2), respectively. Each of the shift registers 25 (1), 25 (2) sequentially store, from a reset state, a data value “1” by shifting it each time the squelch circuits 22 (1), 22 (2) provides a rising edge and a falling edge. Then, a pattern determination unit 26 (i.e., a pattern determination unit in claims) outputs the wakeup signal if the data value stored in each of the shift registers 25 (1), 25 (2) matches the preset pattern.

The advantageous effects of the fourth embodiment are described with reference to FIG. 14. Just like the first embodiment, the node 2C transmits to the nodes 2A, 2B a wakeup command. The node 2C continues reversing the level of the differential signal at first then stops once to drive the communication bus 1 after a lapse of time that is assumed to allow the rise of the level of the signal V3 exceeding the threshold 2 and then exceeding the threshold 1. While the communication bus 1 is not being driven, the level of the signal V3 falls.

Then, after a lapse of time that is assumed to allow the fall of the level of the signal V3 below the threshold 2, the node 2C resumes reversing the level of the differential signal continually. Then, for a lapse of time that is assumed to allow the rise of the level of the signal V3 exceeding the threshold 2 and then exceeding the threshold 1, the node 2C again stops to drive the communication bus 1. The same drive pattern is repeated once more.

By the drive of the communication bus 1 in the above-described manner under control of the node 2C, the wakeup command forms, in the middle of such drive, an intermittent output pattern. The two pulse groups in the former half of FIG. 14(a) correspond to a wakeup-A command, and the three pulse groups including the last one correspond to a wakeup-B command.

The squelch circuits 22 (1), 22 (2) provide a pulse-shape signal at “threshold cross timings” each of which is a timing of the level of the signal V3 crossing the threshold 2 or 1 The threshold 2 and threshold 1 may also be indicated as “low” or “high” respectively, instead of “2” or “1”, such that each time the level of the signal V3 crosses the threshold 2 “low” will be indicated instead of “2”. In such output, the output pulse width from the squelch circuit 22 (2) is wide, and the output pulse width from the squelch circuit 22 (1) is narrow. Further, at each of the rising edge and the falling edge of the pulses, the shift registers 25 (1), 25 (2) of the wakeup determination circuit 24 are triggered to store the data value “1.”

For the ease and clarity of explanation, the data value stored in the shift register 25 (2) is designated as “2.” According to such notation, at a time of output of the wakeup-A command, the data stored in the shift register 25 (1) is “1111,” and the data stored in the shift register 25 (2) is “2222.” Then, the pattern determination unit 26 of the node 2A outputs the wakeup signal when the patterns in the shift registers 25 (1), 25 (2) match with the preset pattern. Further, at a time of output of the wakeup-B command, the data stored in the shift register 25 (1) is “111111,” and the data stored in the shift register 25 (2) is “222222.” Then, the pattern determination unit 26 of the node 2B outputs the wakeup signal when the patterns in the shift registers 25 (1), 25 (2) match with the preset pattern. The shift registers 25 (1), 25 (2) are cleared before transition to the sleep mode.

As described above, the fourth embodiment uses two squelch circuits 22 (1), 22 (2), and sets respectively different thresholds in them, and has a configuration of the wakeup determination circuit 24 that outputs the wakeup signal when the thresholds 1, 2 are crossed by a certain pattern of the rise and the fall of the level of the detection voltage V3 after the first rise of the level exceeding the threshold 2. Therefore, even when there are many nodes 2 connected to the communication bus 1, each of those nodes 2 can respectively determine a sleep mode release request only by having fewer-than-node-number thresholds (i.e., the number of thresholds<the number of nodes). Further, each of the nodes 2A, 2B can be separately started up, which is different from the first embodiment.

Further, the wakeup determination circuit 24 is formed as a combination of the shift registers 25 (1), 25 (2) and the pattern determination unit 26, for the sequential storage of threshold comparison results and for the comparison between the threshold comparison results and the preset pattern. Therefore, by the comparison of the data values in each of the shift registers 25 (1), 25 (2) with the preset pattern in the pattern determination unit 26, each of the nodes 2 can determine the release request for releasing the low electricity consumption mode. Further, even when the two squelch circuits 22 (1), 22 (2) in respective nodes 2 have the same threshold, the wakeup command reception determination of each of those nodes 2 can be set to have a different result based on the setting of the data pattern of the pattern determination unit 26.

According to the communication network system of the fourth embodiment, the startup signal output unit has multiple determination thresholds, and the startup signal output unit outputs the startup signal when a change pattern of the determination voltage level, which forms a pattern of rise and fall of the detection voltage level across the multiple determination thresholds after a first rise across a lowest threshold, matches with a preset pattern. In such manner, even when the network has many nodes, a fewer number of thresholds that are fewer than the number of the network nodes are used to allow the respective nodes to individually determine the release request for releasing the low electricity consumption mode of those nodes.

Additionally, the startup signal output unit includes multiple shift registers for sequentially storing a comparison result with each of the multiple determination thresholds and a pattern comparison unit for comparing a data pattern output from the multiple shift registers with a preset pattern, In such manner, since each of the signal changes that crosses each of the multiple thresholds is stored in the multiple shift registers after the first rise of the detection voltage across the lowest threshold, the pattern comparison unit can determine whether each of the nodes has the release request to release the low electricity consumption mode or not based on the data value in the shift registers.

### Fifth Embodiment

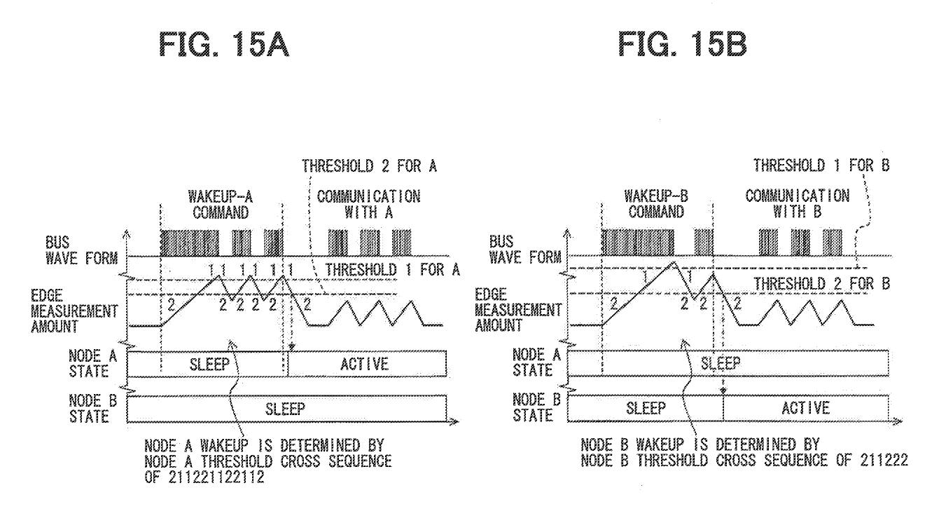

FIGS. 15A and 15B illustrate the fifth embodiment, which is described with a focus to the difference from the fourth embodiment. In the fifth embodiment, the configuration is basically similar to the fourth embodiment, with a difference that the nodes 2A, 2B have respectively different thresholds. That is, for example, in FIG. 15A for the node 2A and FIG. 15B for the node 2B, the threshold 2 has the same value for both of the nodes 2A, 2B, while the threshold 1 is set to have a higher value for the node 2B than the node 2A. The configuration that the threshold is a variable is same as the second embodiment.

Therefore, the wakeup command transmitted by the node 2C is different respectively for the node 2A and for the node 2B. That is, the pattern of the command, or the pulse group intervals or the like, is different for the node 2A and for the node 2B. For the node 2A, when the data in the shift register 25 (1) forms a pattern “111111” and the data in the shift register 25 (2) forms a pattern “222222” according to the output of the wakeup-A command, the pattern determination unit 26 outputs a wakeup signal. For the node 2B, when the data in the shift register 25 (1) forms a pattern “11” and the data in the shift register 25 (2) forms a pattern “2222” according to the output of the wakeup-B command, the pattern determination unit 26 outputs a wakeup signal.

As described above, the thresholds in each node 2 are set to have respectively different values, for the variation of the release request determinations in each of the nodes 2. In the above, the threshold 2 may have different values in nodes 2A and 2B.

According to the communication network system of the fifth embodiment the multiple determination thresholds are set to respectively different values for each of the nodes. Therefore, each of the nodes can determine the release request to itself in various manners.

### Sixth Embodiment

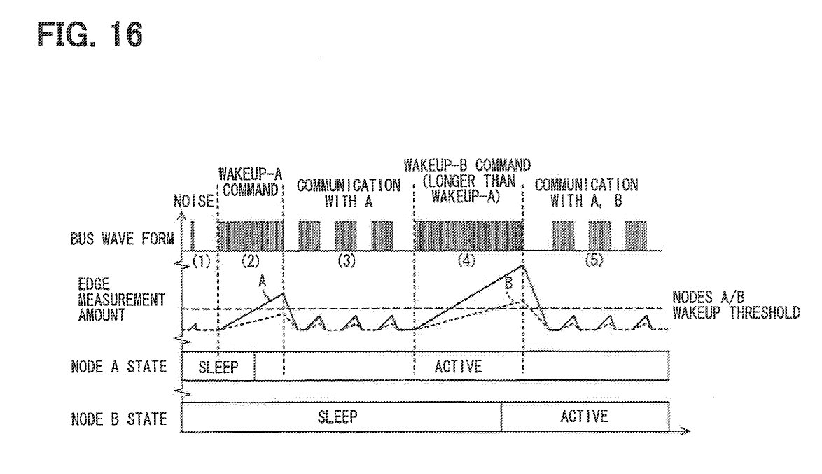

FIG. 16 illustrates the sixth embodiment, in which the squelch circuit 4 in respective nodes 2 are configured such that the rate of increase/decrease (i.e., the slopes) of the level of the signal V3 are respectively different in respective nodes 2 for the same pulse output frequency of the signal V2. For example, in nodes 2A, 2B, the capacitance of the capacitor 17 of node 2A is smaller than the capacitor 17 of node 2B, thereby allowing a faster rate of increase of the signal V3 level, shown in a solid line, for the node 2A, in comparison to the rate of increase of the signal V3 level, shown in a broken line, for the node 2B (see (1)-(5) of FIG. 16).

Therefore, even when the thresholds of the squelch circuits 4 are set to the same value in both of the nodes 2A and 2B, a wakeup-A command having a short output period and a wakeup-B command having a long output period as shown in FIG. 16 are distinguished from each other. In the example of FIG. 16, the node 2A is first started up by the wakeup-A command for performing communication, and then the node 2B is started up by the wakeup-B command for the simultaneous communication with both nodes.

As described above, the squelch circuits 4 in the sixth embodiment have respectively different level rise speeds of the signal V3 in different nodes 2, thereby allowing differentiation of the release request determination conditions for respective nodes 2. Such differentiation is advantageous because, even when the number of different threshold level settings is small, the release request determination conditions are made different for respective nodes 2. The variable selling of the rate of increase/decrease of the detection voltage level in respective nodes 2 is easily achieved, since the capacitance of the capacitor 17 can be variably set by, for example, forming multiple series circuits of the switch and capacitor and by controlling switch on/off of each of the switches in those series circuits according to the register value.

According to the communication network system of the sixth embodiment, the detection voltage levels of the respective nodes are configured to have respectively different rise speeds (i.e. rate of increase). Therefore, even when the number of different threshold level settings is small, the release requests of the respective nodes can be set to have different determination states.

In addition, the change state detection unit (Le. squelch circuit 4) includes the capacitor 17 with a charge voltage level of the capacitor 17 set to rise according to a continuation of the signal change state, and a capacitance of the capacitor 17 is different for each of the nodes. In such manner, the detection voltage level rise speed can be controlled (i.e., changed) according to the capacitance of the capacitor 17 of each node.

### Seventh Embodiment

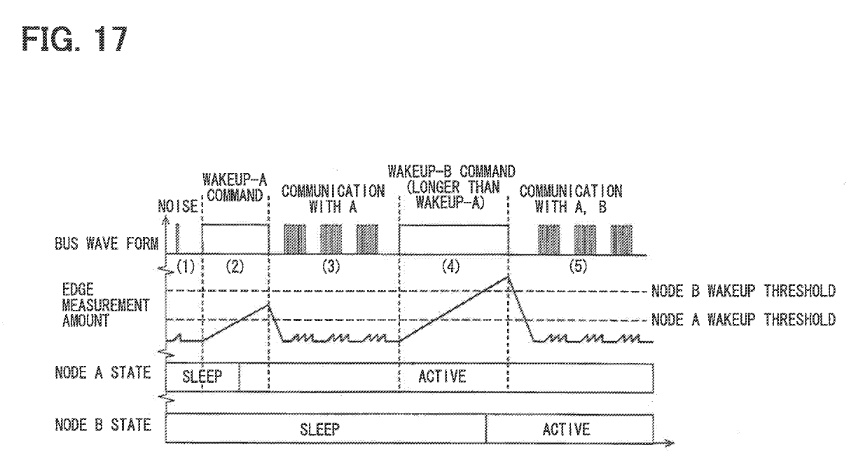

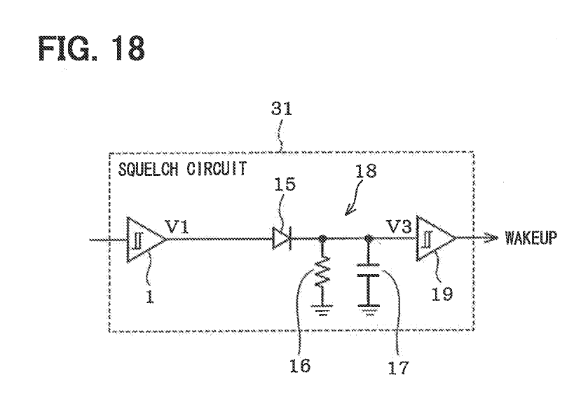

FIGS. 17 and 18 illustrate the seventh embodiment. With reference to FIG. 17, in seventh embodiment the communication bus 1 is kept in a drive state when it transmits the wakeup command, unlike the other embodiments (see (1)-(5) of FIG. 17). A squelch circuit 31 corresponding to such transmission method is shown in FIG. 18. The squelch circuit 31 is similar to the squelch circuit 4, but does not include the rising edge detection circuit 14. The squelch circuit 31 continues to charge the capacitor 17 while the communication bus 1 is in the drive state.

In the seventh embodiment, the squelch circuit 31 is configured to c increase the detection voltage level according to the length of continuation of the signal on the communication bus 1 changed to the drive level. Specifically, the squelch circuit 31 is equipped with the capacitor 17 that is charged while the signal is changed to the drive level, and is also equipped with the Schmitt trigger circuit 19, which compares the charge voltage of the capacitor 17 with a predetermined threshold level. Therefore, the node 2 transitioning to the sleep mode is enabled to determine whether a release request for the node 2 itself is being output or not, based on the detection voltage level which is increased according to the length of continuation of the signal maintained to the drive level, thereby yielding the same advantageous effects as the first embodiment.

According to the communication network system described above, the change state detection unit (i.e. the squelch circuit 31) detects a rise of a detection voltage level that rises according to a continuation period of signal level changed to a drive level. Therefore, the node transiting to the low electricity consumption mode can determine whether the release request to release such low mode transition of the node itself has been output or not, based on the rise of the detection voltage level according to a continuation period of the drive level of the signal.

In addition, the capacitor 17 is charged during a signal level change to the drive level, and the startup signal output unit (i.e., the squelch circuit 31) includes a comparator (i.e. the Schmitt trigger circuit 19) that compares a charge voltage of the capacitor 17 with a preset threshold. In such manner, the capacitor 17 is continuously charged while the signal level is in the drive level, and, when the charge voltage exceeds the threshold level, the comparator outputs the startup signal to the control unit.

### Eighth Embodiment

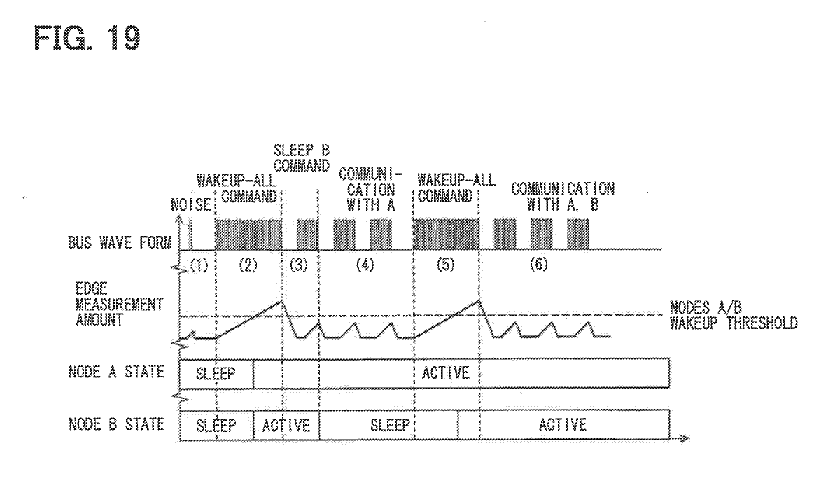

FIG. 19 illustrates the eighth embodiment. In the eighth embodiment, the squelch circuit 4 for each of the nodes 2 has the same threshold. In such manner, the wakeup command output from one of the nodes 2 serves as a wakeup-ALL command, which altogether starts up all the nodes 2 that are in the sleep mode. For example, when the node 2C starts up the nodes 2A, 28 by transmitting the wakeup-ALL command (see (2) in FIG. 19), the node 2C then transmits a command that puts only the node 2B in sleep (see (3) in FIG. 19), and performs communication only with the node 2A (see (4) in FIG. 19). Then, after transmitting the wakeup-ALL command (see (5) in FIG. 19), the node 2C performs communication with both of the nodes 2A, 28, if the node 2C does not put neither of the nodes 2A, 28 in the sleep state.

As described above in the eighth embodiment, when the node 2C transmits the wakeup-ALL command to start up the nodes 2A, 28, it then transmits a command to put the node 2B in the sleep state, and performs communication only with the node 2A. In such configuration, only the node(s) 2 that serves as a communication destination is eventually put in the normal operation mode, as a result of the control.

Further, even in the eighth embodiment, the same thresholds described above for all the nodes 2 may be variably changed as described in the second embodiment. The high/low level setting of the thresholds controls a trade-off between the time for the wakeup determination and a noise margin. Therefore, in the actual communication environment, a higher threshold may be used when the noise influence is strong, and a lower threshold may be used when the noise influence is weak.

Accordingly, the startup signal output unit (i.e., the squelch circuit 4) in each of the nodes 2 has the same threshold, and, when, or after, a communication starting node for starting communication starts up all nodes except the communication starting node by continuing the signal change state on the communication line for a period that is longer than one frame length of the normal communication. Accordingly, the startup signal output unit (i.e., the squelch circuit 4) transmits, to the nodes that do not serve as a communication destination, a “sleep” command for transition of those nodes to the low electricity consumption mode. In such manner, only the nodes that serve as a communication destination are allowed to transition to the normal operation mode.

### Ninth Embodiment

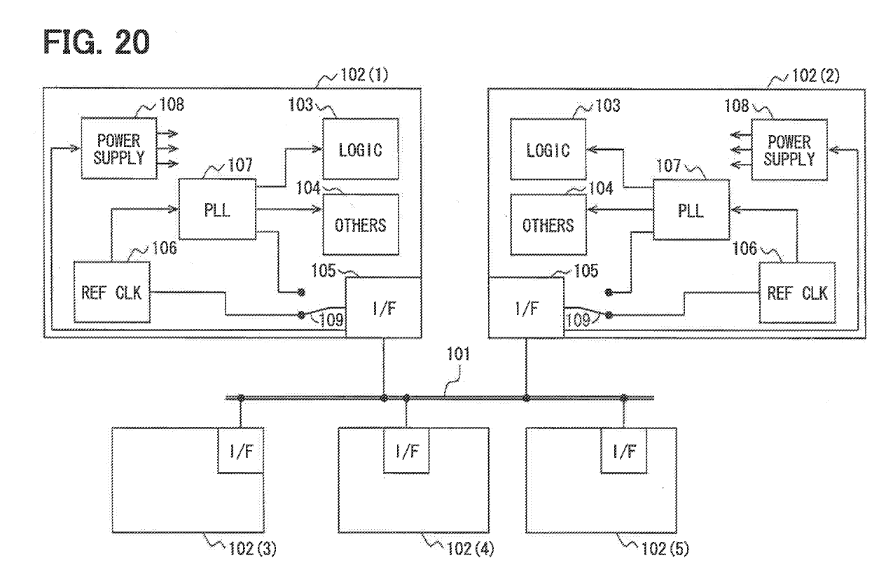

The ninth embodiment of the present disclosure is described in the following with reference to FIGS. 20 to 29. With reference to FIG. 20, a communication network system includes a plurality of chips 102 (1 to 5), which respectively serve as a communication node connected to a communication bus 101 (i.e., a communication line). The basic configuration of each chip 102 is the same, and includes a logic section 103, a periphery circuit 104 (“Others” in FIGS.), an interface section 105 (“I/F” in FIGS.), a reference clock circuit 106, a phase locked loop (PLL) circuit 107, and a power supply section 108.

The logic section 103 is a CPU or a similar part that serves as a control unit for controlling communication. The periphery circuit 104 includes, for example, a timer, an A/D conversion circuit, a memory, and a gate array. The interface section 105 is directly connected to the communication bus 101, and includes a driver for signal transmission and a receiver for signal reception. The logic section 103 transmits a signal to the communication bus 101 through the interface section 105, and receives a signal transmitted on the communication bus 101 through the interface section 105. The communication protocol for the signal transmission may be, for example, Universal Asynchronous Receiver Transmitter (UART), but a different communication protocol may be used.

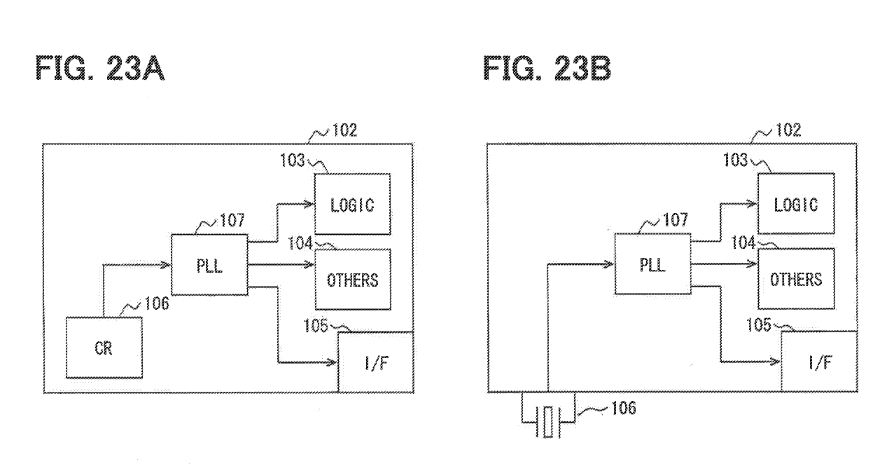

The reference clock circuit 106, or a reference clock output unit in claims, may be, for example, a device that oscillates and outputs a reference clock signal having a frequency in an order of several kHz, such as a CR oscillator circuit in FIG. 23A, or an oscillator circuit having an external oscillation element in FIG. 23B, which is formed as a not-illustrated combination of a crystal oscillator, a resistor element, a capacitor, an inverter gate and the like.

The PLL circuit 107, or a clock multiplication unit, is a device that generates a multiplied clock signal having a frequency in an order of MHz, based on the multiplication of the reference clock signal. The PLL circuit 107 supplies the multiplied clock signal to the logic section 103, the periphery circuit 104, and the interface section 105. The PLL circuit 107 may perform multiplication of PLL oscillation operation either in digital or in analog. The power supply section 108 supplies an electric power for operation to each part of the chip 102. The multiplied clock signal may be referred to as a high frequency clock and the reference clock signal may be referred to as a low frequency clock.

The interface section 105 may be a CPU, or may be a hardware logic in a chip, such as a field-programmable gate array (FPGA) or a power management unit (PMU), or the like. The interface section 105 controls a multiplexer 9 on its own to self-supply one of the reference clock signal or the multiplied clock signal. The interface section 105 also controls the power supply from the power supply section 108 to each part by turning on or off such power supply, as well as other controls. According to such control, the operation state of each chip switches between the active state (i.e., a normal operation mode) and the sleep state (i.e., a low electricity consumption mode).

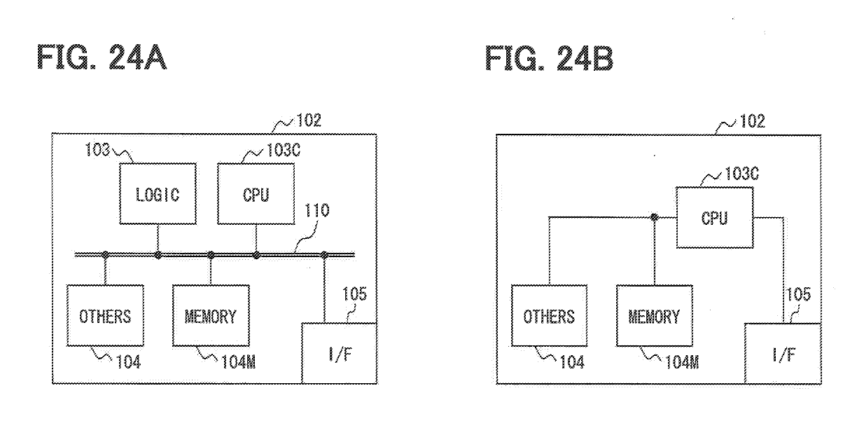

FIGS. 24A, 24B shows connection form examples of each component in the chip 102 (i.e., a partial illustration, omitting some components). In FIG. 24A, a CPU 103C is shown as a separate component from the logic section 103, and a memory 104M is shown as a separate component from the periphery circuit 104, and these components are connected to the interface section through an internal bus 110. In FIG. 24B, the CPU 103C is connected to the periphery circuit 104 and the memory 4M through a common local bus, and the CPU 103C and the interface section 105 are separately connected through a dedicated bus. In the example of FIG. 24A, the internal bus 110 may have a layered structure, and, in the example of FIG. 24B, the components other than the interface section 105 may directly be connected to the CPU 103C. Such modification may arbitrarily be adopted.

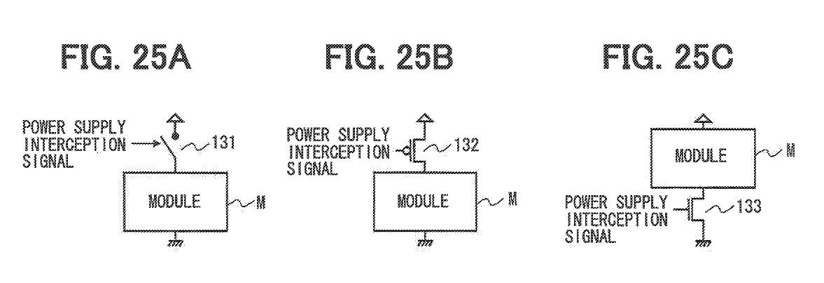

FIGS. 25A to 25C are examples of ways the interface section 105 may control (i.e., turns ON/OFF) the power supply for each component from the power supply section 108. In such examples, a module M corresponds to the destination of the power supply, such as the logic section 103, the periphery circuit 104, the PLL circuit 107, or the like. In the example of FIG. 25A, a switch 131 is inserted between the power supply and the module M, and the switch 131 is controlled by a power supply interception signal which is output by the interface section 105, for controlling the power supply for the module M. Further, for example, the switch 131 may be an analog switch.

In the example of FIG. 25B, a P channel MOSFET 132 is inserted between the power supply and the module M, and the P channel MOSFET 132 is switched ON/OFF by the power supply interception signal which is output by the interface section 105. In the example of FIG. 25C, an N channel MOSFET 133 is inserted between the module M and a ground, and the N channel MOSFET 133 is turned ON/OFF by the power supply interception signal which is output by the interface section 105. In such case, the logic of the power supply interception signal is an inversion of the example of FIG. 25B. Further, separately from the examples in FIG. 25A to FIG. 25C, a switch may be inserted in the middle of a power supply line that is connected to each of the destinations of the power supply, and such switch may be controlled, that is, turned ON/OFF.

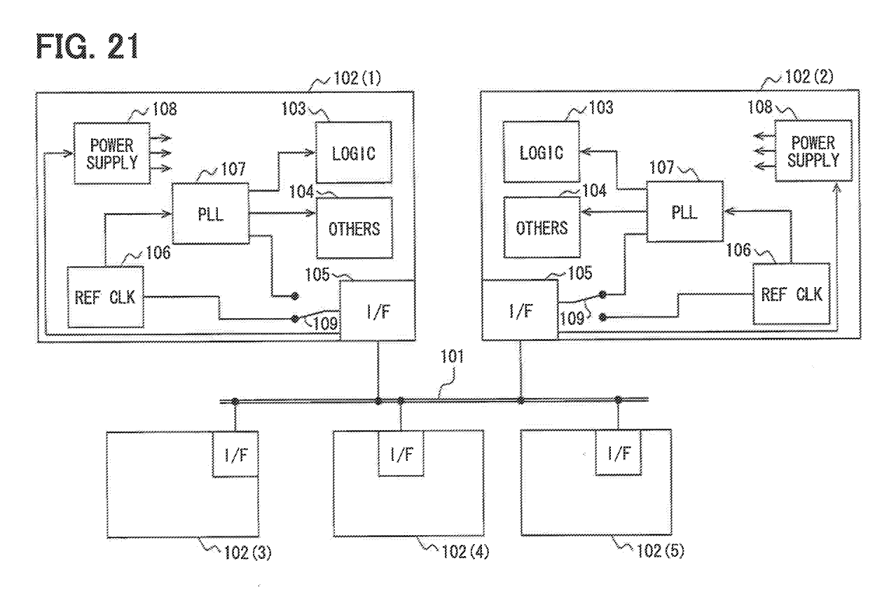

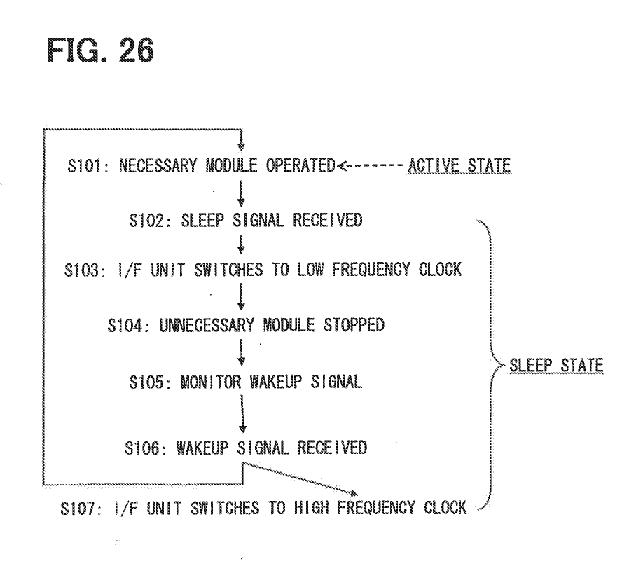

The advantageous effects of the present disclosure are described with reference to FIGS. 21-22, 26-29. FIG. 26 provides a transition state of the chip 102, where in S101 the chip 102 is in the active state and in S102 to S107 the chip is in the sleep state. At least one of the chips 102 includes a function to manage the power supply of the entire network system, and is referred to as a management chip or a management node. The management chip 102 may provide to the other chips 102 a sleep signal (i.e., a sleep command) and/or a wakeup signal (i.e., a wakeup command), where the sleep signal has the other chips 102 transition from the active state to the sleep state and wakeup signal has the other chips 102 transition from the sleep state to the active state.

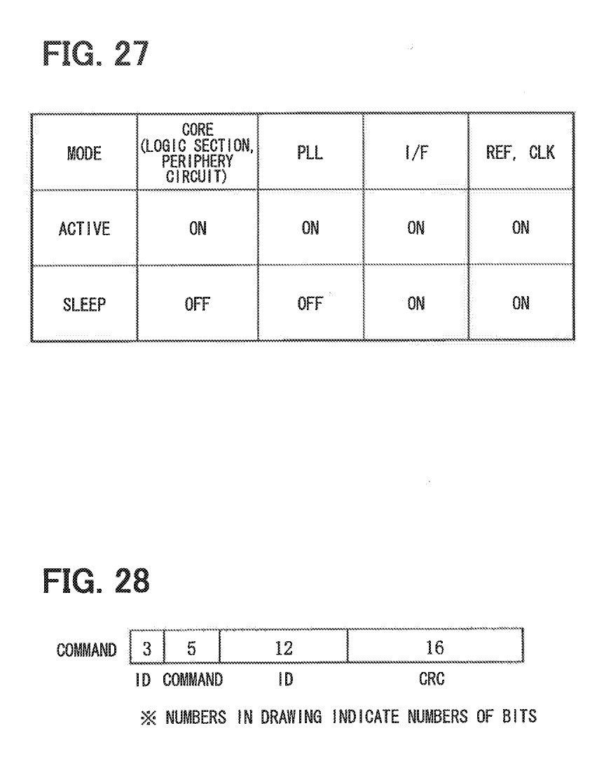

FIG. 27 is a chip state table that shows a relationship between the active/sleep state and ON/OFF operation of each component, When the chip 102 is in the active state the PLL circuit 107, the interface section 105, the reference clock circuit 106, and the core components, which include the logic section 103 and the periphery circuit 104, have the power supply turned ON, and the multiplied clock signal is supplied to the interface section 105. When the chip 102 is in the sleep state, the power supply for the core components and the PLL circuit 107 is turned OFF, and the interface section 105 and the reference clock circuit 106 remains ON, and the reference clock signal is supplied to the interface section 105.

With continuing reference to FIG. 26, when the chip 102 in the active state (S101) receives the sleep signal (S102), the interface section 105 switches itself so that the reference clock signal (i.e., a low frequency clock) is supplied to the interface section 105 (S103). The interface section 105 then stops the power supply for the modules that need not be operated, which includes the core components and the PLL circuit 107 (S104), and then puts itself in a wait state for monitoring the reception of the wakeup signal (S105). For example, in FIG. 20 chips 102 (1), 102(2) are in the sleep state.

FIG. 28 shows an example of a command frame of the wakeup signal. The wakeup signal has the following configuration,
Identifier (3 bits): indicates that a frame is a command frame.
Command (5 bits): indicates that it is a wakeup command.
ID (12 bits): indicates an ID (i.e., identification) of the chip 102 that is an object to be waken up.
CRC (16 bits): data for error detection.

The wakeup signal having the above configuration is transmitted at a low communication rate based on the reference clock signal.

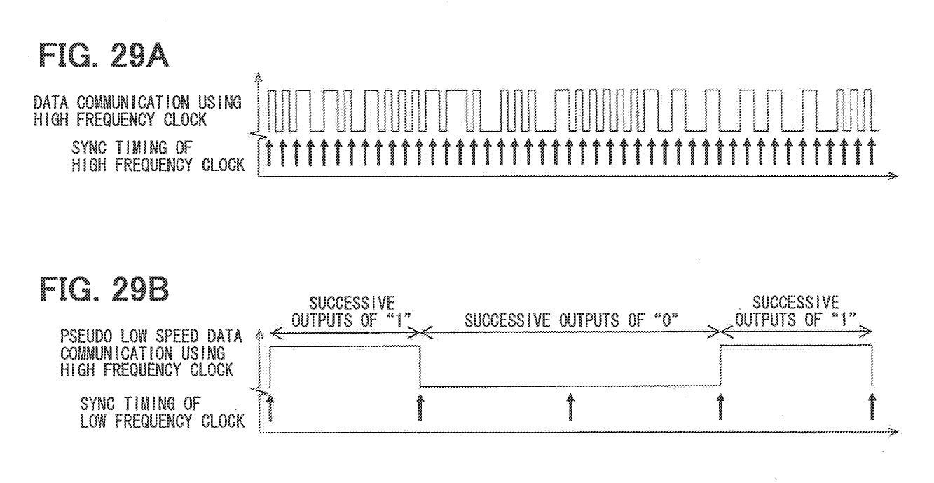

FIGS. 29A, 29B, are timing charts of the transmission of the wakeup signal by the chip 102 in the active state, at a low speed communication rate. FIG. 29A is a timing of the signal transmitted at a communication rate that is based on the multiplied clock signal (i.e., high frequency clock) and FIG. 29B is a timing of the signal transmitted at a communication rate that is based on the reference clock signal. Note that the cycle ratios of the clock signals of FIG. 29A and 29B do not reflect an actual ratio, since the timing chart is for illustration purpose only.

When the chip 102 in the active state performs signal transmission at timings shown in FIG. 29A, the chip 102 transmits the wakeup signal in synchronization with the low speed communication rate that is based on the reference clock signal in FIG. 29B (shown as low frequency clock), because the chip 102 transmits the wakeup signal to the chip 102 in the sleep state. In other words, it transmits the data value “1” and “0” successively only at required timings at a high speed communication rate, for the synchronization with the low. speed communication rate.

With continuing reference to FIG. 26, when the chip 102 in the sleep state receives the wakeup signal (S106), the interface section 105 switches to the multiplied clock signal (i.e., a high frequency clock) (S107), and supplies the power for the core components and the PLL circuit 107 (S101). In such manner, each module of the chip 102 operates at a high rate by the multiplied clock signal.

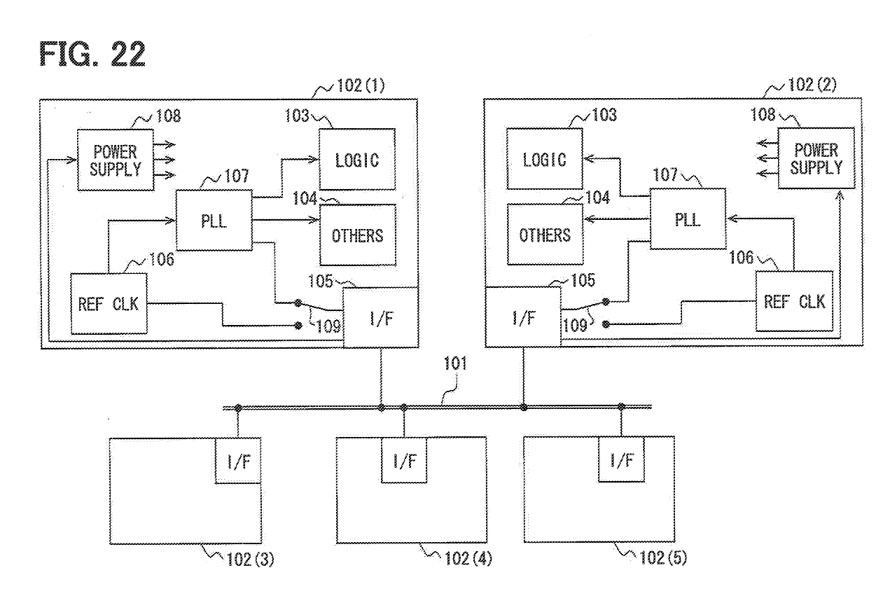

FIG. 21 shows a state in which the chip 102 (2) has been switched to the active state due to the transmission of the wakeup signal from the chip 102 (3) to the chip 102 (2). Further, FIG. 22 shows a state in which the chip 102 (1) is also switched to the active state. Therefore, in FIG. 22, a high speed communication between the chip 102 (1) and the chip 102 (2) is enabled.

According to the present embodiment, each chip 102 is equipped with the interface section 105 that controls itself to have selective supply of the multiplied clock signal and the reference clock signal, and controls the operation of the PLL circuit 107 to transmit/receive the signal through the communication bus 101. Further, the chip 102 in the sleep state stops the operation of the PLL circuit 107, stops the power supply to the logic section 103 and the periphery circuit 104 (i.e., core components), and supplies the reference clock signal for itself. When the interface section 105 receives the wakeup signal transmitted from the management chip 102, it starts the operation of the PLL circuit 107, turns on power supply to the logic section 103 and the periphery circuit 104, and connects to the multiplied clock signal.

Therefore, in the sleep state, the operation is limited only for the interface section 105 which has a supply of the reference clock signal, thereby sufficiently reducing the power consumption. Then, upon receiving the wakeup signal, the interface section 105 starts the operation of the PLL circuit 107 and supplies the reference clock signal to the interface section 105 itself, thereby enabling the logic section 103 to operate at “high speed” for performing the normal communication. In addition, there is no need to have additional lines for exclusively starting up the chips 102 that serve as the communication destination, which leads to the reduction of the number of communication lines.

Further, if the interface section 105 transmits the startup signal to the other chips 102 in the normal operation mode, it transmits the startup signal at the communication rate set by the reference clock signal in a state in which the interface section 105 has the multiplied clock signal supplied for itself. Therefore, the interface section 105 can transmit the startup signal at low speed without switching the clock signal supplied for itself.

### Tenth Embodiment

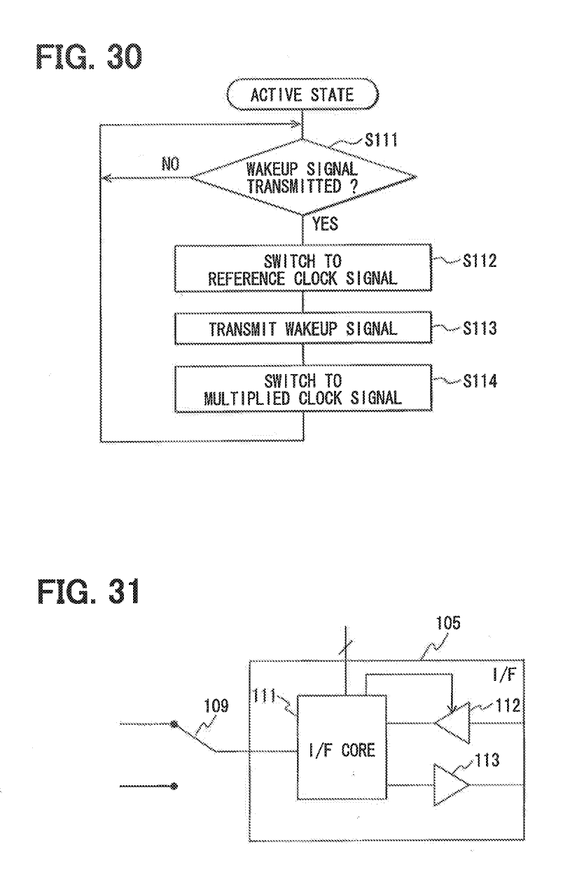

FIG. 30 illustrates the tenth embodiment, in which the chip 102 in the active state transmits, to the chip 102 in the sleep state, a wakeup signal by a technique that is different from the one in FIG. 29. FIG. 30 is a flowchart of a process performed in the chip 102 in the active state. Like parts of the ninth embodiment have like numbers in the present embodiment, and description of the like parts is omitted.

In FIG. 30, the logic section 103 of the chip 102 in the active state waits until a cause for transmitting the wakeup signal to the other chip 102 (step S111) is generated. Then, when such cause is generated (step S111:YES), the process switches the multiplexer 9 to supply the interface section 105 with the reference clock signal (step S112), and transmits the wakeup signal (step S113). In such manner, the wakeup signal is transmitted at the low speed communication rate that is set by the reference clock signal. After transmitting the wakeup signal, the process switches the multiplexer 9 to supply the multiplied clock signal to the interface section 105 (step S114), and the process proceeds to step S111.

According to the present embodiment, the interface section 105 can transmit a wakeup signal to itself at the low speed communication rate as described above when it transmits the wakeup signal to the other nodes in the normal operation mode because it switches to supply the reference clock signal to itself. Further, in such case, the entire chip 102 may transition to the sleep state while it performs step S112 and step S113.

### Eleventh Embodiment

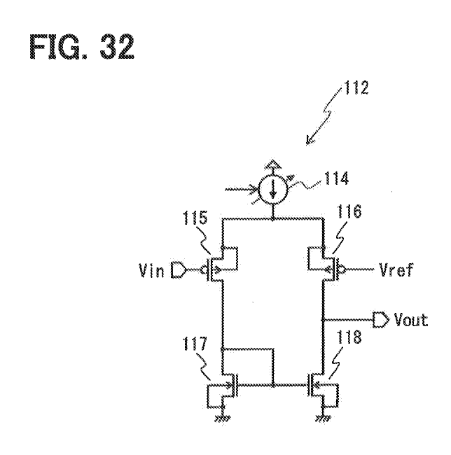

FIGS. 31 and 32 illustrate the eleventh embodiment. The difference of the eleventh embodiment from the ninth embodiment is described in the following. In the present embodiment, when the chip 102 in the active state transitions to the sleep state, the interface section 105 performs other processes.

FIG. 31 is a block diagram of an internal configuration of the interface section 105, which includes an interface core 111, an input buffer 112 (i.e., a receiver), and an output buffer 113 (i.e., a driver). The input buffer 112 receives a signal transmitted on the communication bus 101, and outputs it to interface core 111. Then, the interface core 111 decodes/demodulates/serial-parallel converts the received signal to output it to the CPU 103C. Further, the interface core 111 transmits a signal on the communication bus 101 through the output buffer 113 after parallel-serial conversion/modulation/coding of the signal when, for example, it receives the signal from the CPU 103C.

FIG. 32 shows an example of a circuit of the input buffer 112. The power source of the circuit of the buffer 112 is connected to an electric power source 114 from which a variable electric current is provided as setting, and, to the electric power source 114, a source of P channel MOSFET 115 and a source of P channel MOSFET 116 are connected. Between a drain of P channel MOSFET 115 and a ground of P channel MOSFET 116, N channel MOSFETs 117 and 118 are connected, respectively. A gate of N channel MOSFET 117 and a gate of N channel MOSFET 118 are connected to a drain of N channel MOSFET 117, thereby forming a mirror pair.

A gate of P channel MOSFET 115 serves as an input terminal Vin of the input buffer 112, and a gate of P channel MOSFET 116 is provided with a reference voltage Vref. Further, a drain of N channel MOSFET 118 serves as an output terminal Vout of the input buffer 112.

The interface core 111 is configured to reduce the amount of power supply electric current supplied by the electric power source 114 when it transitions to the sleep state. In such manner, the I/O response speed (i.e., response sensitivity) of the input buffer 112 is lowered, and can reduce the electric consumption of the input buffer 112. In other words, since the input buffer 112 in the sleep state is only required to receive the wakeup signal that is transmitted at the low speed communication rate, lowered response sensitivity is not a problem.

Further, by lowering the sensitivity of the input buffer 112 in the above-described manner, a possibility of a false wakeup of the chip 102 in the sleep state under the influence of the communication performed at the high speed communication rate is decreased. Further, for the prevention of the false wakeup, the management chip 102 (i.e., the management node) for managing the system power may intermittently transmit the sleep signal to the chip 102 that is not required to be started up. In addition, even when each of the chips 102 is in the active state, the reception of the wakeup signal may be monitored as shown in the ninth embodiment, and the chip 102 not receiving the wakeup signal for a preset period may be put in the sleep state.

According to the eleventh embodiment, the interface section 105 lowers the I/O response speed of the input buffer 112, which is receiving a signal in the sleep state as described above. More practically, the interface section 105 reduces the amount of the power supply electric current supplied for the input buffer 112. In other words, because the communication between the chips in the sleep state is performed at the low speed, the reduction of the I/O response speed of the input buffer 112 does not cause a problem in the communication, thereby enabling the reduction of the electric power consumption by the input buffer 112.

Further, by assigning the system management function to one of the plurality of chips 102, which serves as a management node, such chip 102 can intermittently transmit the sleep signal to the chip 102 that is not required to be started up, thereby putting, or returning, in the sleep state a falsely started-up chip 102 that has been started up falsely under the influence of the noise or the like.

According to the communication network system of the eleventh embodiment, the interface section 105 lowers, in the low electricity consumption mode, a response speed and a response sensitivity of an input and an output of a receiver for receiving the signal. In other words, since the communication between the nodes in the low electricity consumption mode is performed at a low speed, the lowered response speed or lowered response sensitivity does not affect the communication. Therefore, lowering the response speed/sensitivity reduces the electricity consumption without causing problem.

In addition, the interface unit 105 reduces an amount of a power supply electric current supplied for the receiver. By reducing the amount of the power supply (i.e., the supplied electric current) to the receiver, the receiver's response speed is lowered and the electricity consumption is reduced.

Also, one of the nodes is a management node having a function of managing an entire system, and the management node periodically transmits, to the other node that needs not be started up, a signal transitioning the other node to the low electricity consumption mode. In other words, there may be a situation in which a node transitioning to the low electricity consumption mode is falsely started up based on a false determination that the node has received the startup signal, under influence of the noise, or under influence of communication between two nodes in the normal operation mode. Therefore, by intermittently or periodically transmitting from the management node a signal that puts a falsely waken-up node to transition back to the normal operation mode, such falsely waken-up node can transition back to the low electricity consumption mode.

### Twelfth Embodiment

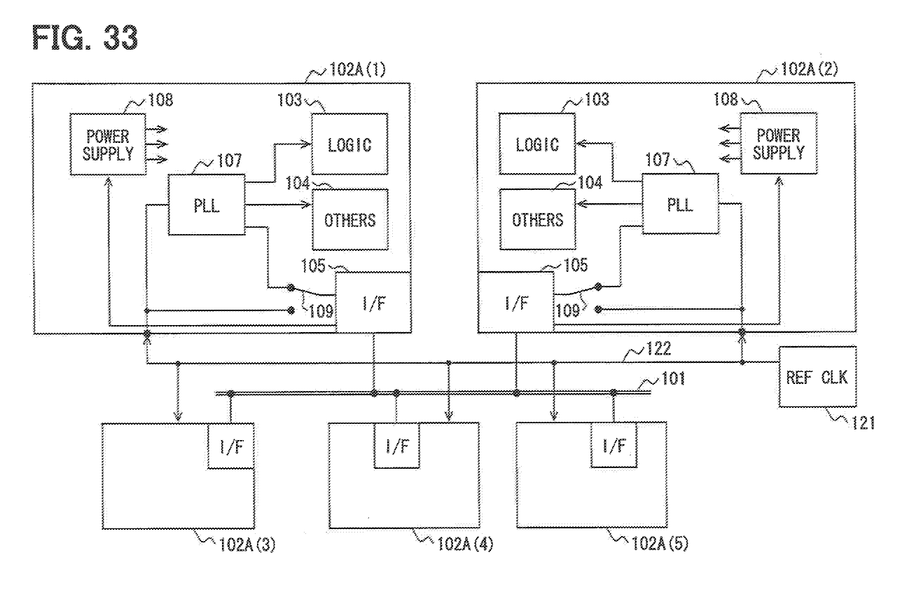

FIG. 33 illustrates the twelfth embodiment, in which each of chips 102A is not equipped with the reference clock circuit 106 and, instead, the system has one reference clock circuit 121 that provides the reference clock signal to each of the chips 102A via line 122. Thus, due to such difference from the ninth embodiment, the reference clock signal is input through a reference clock line 122 to the PLL circuit 107 of each of the chips 102A. In such manner, the volume of the chip 102A is reduced, and all chips 102A are synchronized under the same reference clock signal.

### Thirteenth Embodiment

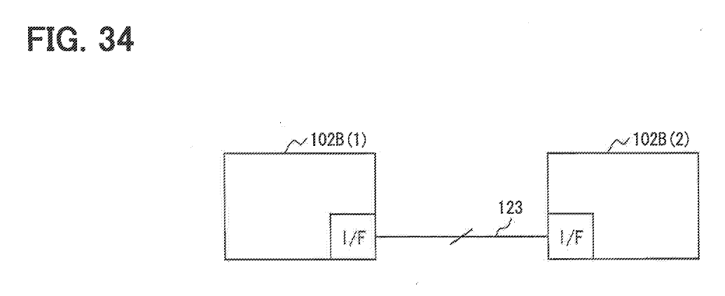

FIG. 34 illustrates the thirteenth embodiment, in which the difference from the ninth embodiment is that a chip 102B (1) and a chip 102B (2) are directly connected by a communication line 123, for the communication therebetween. Even in such configuration, one of chips 102B (1), 102B (2) may have the system power management function, and the wakeup signal may be transmitted from the one to the other of the two chips 102B (1), 102B (2), to transition the chip from the sleep state to the active state for communication. The chip 102B having the system power management function may not necessarily be in the active state. That is, such chip 102B (i.e., the management chip 102B) may usually be put in the sleep state, and may at regular intervals be started up, by a timer or by an external signal, for performing a required communication process, and may then be returned to the sleep state.

### Fourteenth Embodiment

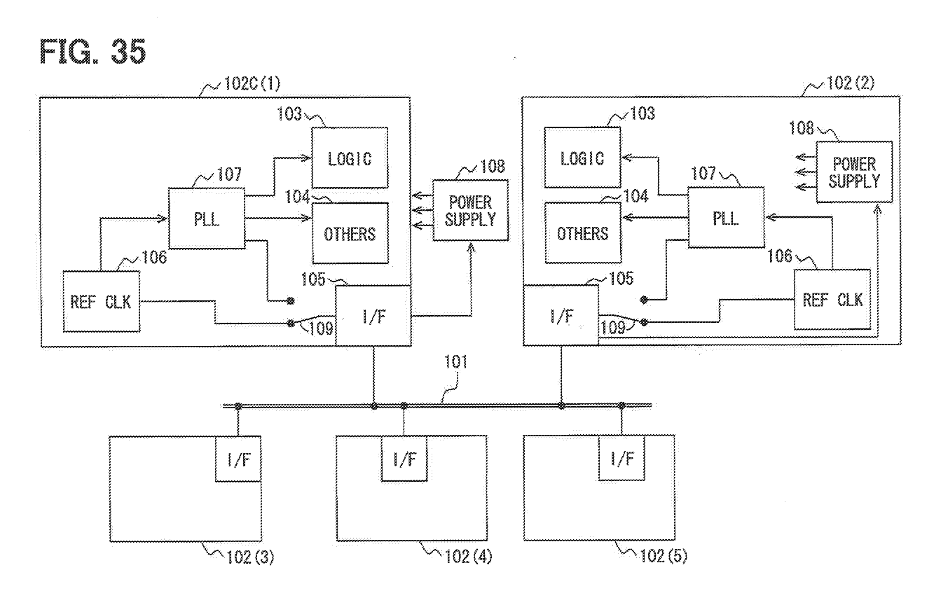

FIG. 35 illustrates the fourteenth embodiment, in which the chip 102 (1) in FIG. 20 is replaced with a chip 102C (1), which is a difference from the ninth embodiment. The power supply section 108 of the chip 102C (1) is external to the chip 102C (1), and the interface section 105 outputs the power supply interception signal to the power supply section 108 to control the power supply for each part. The power supply control may be performed in the same manner as the configuration shown in FIG. 25. Further, the chip 102 (2) may be configured in the same manner as the chip 102C (1), to use it as the chip 102C (2). Such configuration may have the same advantages as the ninth embodiment.

### Fifteenth Embodiment

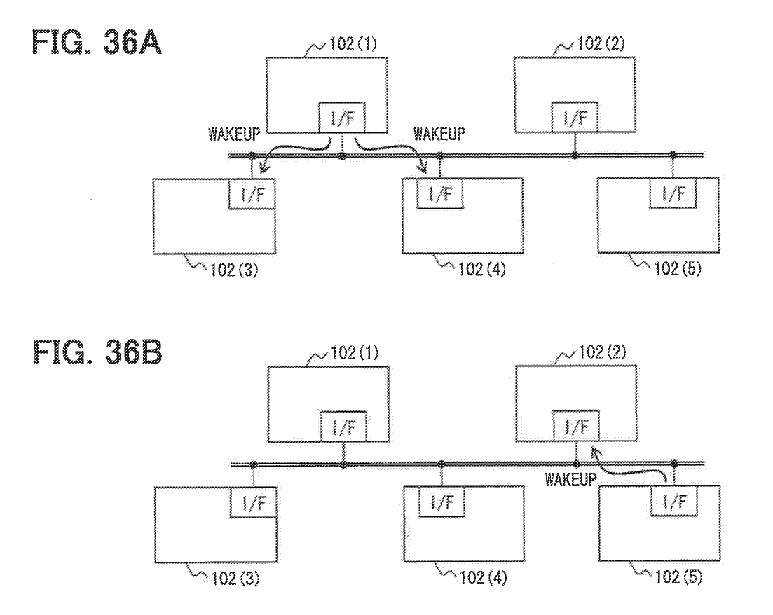

FIG. 36A and 36B illustrates the fifteenth embodiment, in which a master's right for communication is transferred among the chips 102 (1) to 102 (5). The master's right is equivalent to the right for transmitting the wakeup signal. The chip 102 having the master's right can transmit the wakeup signal to other chips 102. Any one of the chips 102 can have the master's right. How the master's right is transferred among the chips 102 is beyond the scope of the present disclosure, and is not described in detail.

In the example of FIG. 36A, the chip 102 (1) is provided as or has acquired the master's right, and transmits the wakeup signal to the chips 102 (3), 102 (4) (i.e., slaves), which are in the sleep state and are the communication destination. In the example of FIG. 36B, the chip 102 (5) is designated as or has acquired the master's right, and transmits the wakeup signal to the chip 102 (2) (i.e., slave), which is in the sleep state and is the communication destination.

As described above, the wakeup signal in the present embodiment is transmitted by the chip 102 which is provided as the master's right for communication. Therefore, even when the chip 102 that should transmit the wakeup signal has not been determined in advance, a chip 102 having acquired the master's right, which needs to start up the communication destination chip 102, can transmit the wakeup signal.

Although the present disclosure has been fully described in connection with embodiments described thereof with reference to the accompanying drawings, it is to be noted that various changes and modifications will become apparent to those skilled in the art.

For example, the change state detection unit may be formed by a counter for counting the edge output numbers of the transmission data, for example.

The present disclosure may not only be applicable to the signal transmission line using the differential signal but also be applicable to a single end type transmission line.

The present disclosure may be applicable to the communication network having more than 4 nodes.

The wiring topology of each node is not limited a specific one.

The command frame of the wakeup signal in FIG. 28 is only an example, and such example does not restrict the modification of the command frame of the wakeup signal.

A block having the PMU function may be provided separately from the interface section 106, and the interface section 105 may instruct the PMU to control the power supply for each part.

In the eleventh embodiment, a low speed input buffer that consumes little electric power may be separately provided, and such input buffer may be used in the sleep state.

Regarding the frequency difference between the reference clock signal and the multiplied clock signal, the difference may be set according to the s individual system design.

Such changes, modifications, and summarized schemes are to be understood as being within the scope of the present disclosure as defined by appended claims.

What is claimed is:

1. A communication network system comprising:
a communication line; and
a plurality of nodes disposed on the communication line, each of the nodes being able to transition between a normal operation mode and a low electricity consumption mode, each of the plurality of nodes including a control unit performing a communication control, a change state detection unit detecting a signal change state of the communication line, and a startup signal output unit outputting a startup signal to the control unit according to a continuation time of the signal change state, wherein
at least one of the plurality of nodes is a communication starting node, the communication starting node controlling other node to transition from the low electricity consumption mode to the normal operation mode by controlling the signal change state on the communication line for a period greater than one frame length of a normal communication, and
when the change state detection unit of a subject node transitioning to the low electricity consumption mode detects the signal change state for a period greater than a threshold assigned to the subject node, the startup signal output unit of the subject node provides the startup signal to the control unit of the subject node to transition to normal operation mode.

2. The communication network system of claim 1, wherein the change state detection unit detects an increase of a detection voltage level that increases according to a continuation period of signal level reversing change.

3. The communication network system of claim 1, wherein
the change state detection unit includes a pulse signal output unit for providing a pulse signal at a time of one-way reversing of a signal level and a capacitor that is charged by the pulse signal, and
the startup signal output unit includes a comparator for comparing charge voltage of the capacitor with a preset threshold.

4. The communication network system of claim 1, wherein the change state detection unit detects an increase of a detection voltage level that increases in proportion to a continuation period of signal level changed to a drive level.

5. The communication network system of claim 4, wherein
the change state detection unit includes a capacitor that is charged during a signal level change to the drive level, and
the startup signal output unit includes a comparator that compares a charge voltage of the capacitor with a preset threshold.

6. The communication network system of claim 2, wherein
the startup signal output unit has multiple determination thresholds, and
the startup signal output unit provides the startup signal when a change pattern of the determination voltage level matches with a preset pattern, the change pattern provided by a rise and fall of the detection voltage level across the multiple determination thresholds that is detected after a first rise of the detection voltage level across a lowest threshold.

7. The communication network system of claim 6, wherein the startup signal output unit includes multiple shift registers for sequentially storing a comparison result with each of the multiple determination thresholds and a pattern comparison unit for comparing a data pattern output from the multiple shift registers with the preset pattern.

8. The communication network system of claim 6, wherein the multiple determination thresholds are set to respectively different values for each of the nodes.

9. The communication network system of claim 2, wherein the detection voltage levels of the nodes are configured to have respectively different rise speeds.

10. The communication network system of claim 9, wherein
the change state detection unit includes a capacitor with a charge voltage level of the capacitor set to rise according to a continuation of the signal change state, and
the capacitance of the capacitor is different for each of the nodes.

11. The communication network system of claim 1, wherein
the threshold of each of the plurality of nodes is the same, and
after the communication starting node transitions the other nodes to the normal operation mode by continuing the signal change state on the communication line for a period that is longer than one frame length of the normal communication, the startup signal output unit transmits a command for transitioning to the low electricity consumption mode to a node that does serve as a communication destination.

12. The communication network system of claim 1, wherein the threshold of the change state detection unit is changeable.

13. The communication network system of claim 12, wherein
the change state detection unit is configured to increase a level of an output voltage according to a continuation period of the signal change state,
the startup signal output unit includes a comparator for comparing the level of the output voltage with the threshold, and
the threshold set in the comparator is changeable.

14. The communication network system of claim 12, wherein each of the plurality of nodes includes a transmission side that transmits a change command to perform a threshold change.

15. The communication network system of claim 12, wherein each of the plurality of nodes includes a reception side that changes the threshold immediately before transitioning to the low electricity consumption mode.

16. The communication network system of claim 12, wherein each of the plurality of nodes includes a reception side that changes the threshold immediately after transitioning to the normal operation mode.

17. A communication network system comprising:
a communication line; and
a plurality of nodes disposed on the communication line, each of the plurality of nodes being capable of transitioning between a normal operation mode and a low electricity consumption mode, and each of the plurality of nodes including:
a clock multiplication unit outputting a multiplied clock signal that is a multiplication of a reference clock signal,
a control unit performing a communication control when operating according to the multiplied clock signal,
an interface unit controlling itself to have a selective supply of one of the multiplied clock signal and the reference clock signal for controlling the clock multiplication unit and for transmitting and receiving a signal through the communication line, and
a power supply unit capable of stopping a power supply for the control unit, wherein
the interface unit, in the low electricity consumption mode, prohibits operation of the clock multiplication unit, stops the power supply for the control unit, and supplies the reference clock signal for itself, and
the interface unit starts, upon receiving a startup signal, the operation of the clock multiplication unit, and starts to have the multiplied clock signal supplied to itself.

18. The communication network system of claim 17, wherein
the interface unit, in the low electricity consumption mode decreases a response speed and a response sensitivity of an input and an output of a receiver for receiving the signal.

19. The communication network system of claim 18, wherein the interface unit reduces the amount of a power supply electric current supplied for the receiver.

20. The communication network system of claim 17, wherein the interface unit of a node switches to supply the reference clock signal to itself when transmitting the startup signal to another node in the normal operation mode.

21. The communication network system of claim 17, wherein when the interface unit of a node transmits the startup signal to another node, the interface unit transmits the startup signal at a communication rate set by the reference clock signal in a state of having the multiplied clock signal supplied to itself.

22. The communication network system of claim 17, wherein
one of the plurality of nodes is a management node that has a management function for managing an entire communication network system, and
the management node periodically transmits, to a node that is not required to be started up, a signal transitioning the node to the low electricity consumption mode.

23. The communication network system of claim 17, wherein a node having acquired a master's right of communication transmits the startup signal.
